(19) United States
(12) Patent Application Publication
(10) Pub. No.: US 2021/0209582 A1
(43) Pub. Date: Jul. 8, 2021

(54) VIRTUAL SMART CARD FOR BANKING AND PAYMENTS

(71) Applicants: Swapnil PALIWAL, MUMBAI (IN); ANVITA CHANDRAKAR, RAIPUR (IN); SUYASH PALIWAL, MUMBAI (IN)

(72) Inventors: SWAPNIL PALIWAL, MUMBIA (IN); ANVITA CHANDRAKAR, RAIPUR (IN); SUYASH PALIWAL, MUMBAI (IN)

(21) Appl. No.: 17/058,828

(22) PCT Filed: Jun. 6, 2018
(86) PCT No.: PCT/IN2018/050367

§ 371 Date: Nov. 25, 2020

(30) Foreign Application Priority Data
Jun. 1, 2018 (IN) 201821020584

(51) Int. Cl. G06Q 20/34; G06Q 20/40; G06Q 20/32; G06Q 20/38; G06Q 20/18

(52) U.S. Cl. CPC G06Q 20/351; G06Q 20/4014; G06Q 20/4012; G06Q 2220/00; G06Q 20/3829; G06Q 20/18; G06Q 20/3274

(57) ABSTRACT

The Present Invention focuses on performing banking operation at kiosk unit (an ATM) without the use of conventional physical smart cards. A special type of card called a Virtual Smart Card (V.S.C) is deployed by the bank authority which is portable on any smart device which a user possesses and this V.S.C is such that it can be only accessed in the presence of an interface provided by the bank authority. We later depict as of how a V.S.C can emulate normal physical smart cards for performing banking operation and also as of how this V.S.C can be used for making payment to merchants or on the websites when user desires. A special type of V.S.C and interface called merchant V.S.C and S-interface is provided to merchants by the bank authority such that it can be deployed easily on multiple devices such that multiple agents working under a merchant can use it for collecting payment. The payment is done by user by just scanning the QR code on the special interface which a merchant possesses and confirming the transaction amount. Moreover when user desires to make payment on the website the user need not enter card credentials; here transaction is processed in such a manner that user credentials are never exposed. The V.S.C is deployed such that the user can update the credentials of the V.S.C by accessing the interface at the kiosk unit. In general the invention focuses on emulating physical smart cards and depicting how online transactions and transactions at the kiosk can be performed using Virtual Smart cards.

### FIELD OF INVENTION

Present Invention relates to a method of performing banking and payment related transaction and operation at the kiosk unit, merchant device and web server interface with the help of a virtual smart card, an interface and an electronic device.

### PRIOR ART

6654/2018-CO/SW (Indian Copyright Diary Number) Entitled “Key exchange protocol with public modulo and hidden primitive root” this is a Non Patent, unpublished work which is submitted for copyright by us. This copyright comprises of a key exchange protocol where primitive root is hidden and only using the public modulo the entities proceed the communication and perform necessary operations at respective steps. We depict the basic key exchange Protocol and then depict as of how key exchange takes place in an authenticated model. We depict the flow of protocol, here the initiator generates a cyclic sub-group G over a prime field [symbol] ₚ of prime order q and a generator x in G, and publishes only the prime modulo q so that the receiver can choose secret one time ephemerals and perform operation using them and reduce on the given modulo q, here in this protocol the entity A generates secret keys {x,x₉,p,x₂,x₄}∈ [symbol] *_{q} where {x,x₄}∈ [symbol] *_{q} are a set of generators ({x₄} need not be a generator always, section D depicts the same) of the cyclic group G and entity B generates secret keys {x₁,s,x₃}∈ [symbol] *₃ using which both the entities attain a common shared session key. The following are the steps in our proposed key exchange protocol. STEP1: Entity A produces one time ephemerals {x₀,p,x₂,x₄}∈ [symbol] *_{q} using which the entity A computes SK₁=x₀*x^{p} mod(q) and reverts it to entity B; this is the first step using which the communication is preceded further. STEP2: Entity B after successfully attaining SK1 then generates its one time ephemerals {x₁,s,x₃}∈ [symbol] *_{q} and computes SK₂=x₁*[x₀*x⁹]^{z} mod(q) and revert it to entity A. STEP3: Entity A attains SK2 and using the previously generated ephemeral {x₂,p} entity A proceeds by computing SK₃=x₂*[x₁*x₀²*x^{ps}]^{p}^{¹} mod(q) and sends it to entity B. STEP4: Entity B using SK3 and ephemeral {x₃,s} computes SK₄=x₃*[x₂*x₁^{p}^{^{−1}}*x₀^{p}^{^{−}}^{s}*x⁵]^{z}^{^{−1}} mod(q) and send it to entity A. STEP5: Entity A using SK4 eliminates {x₀x} by performing [SK₄]^{p}*[[x₀*x^{p}]]⁻¹ mod(q)=[x₃*x₂^{s}^{^{−1}}*x₁^{p}^{^{−1}}^{s}^{^{−1}}]^{p} mod(q) and with the intermediate result and with the uses of ephemeral {x₄} the entity A computes SK₅=x₄*[x₃*x₂^{s}^{^{−1}}*x₁^{p}^{^{−1}}^{s}^{^{−1}}]^{p} mod(q) and send it back to entity B. STEP6: Entity B using SK5 eliminates {x₁} by computing [SK₅]^{s}*[x₁]⁻¹ mod(q)=x₄²*x₃^{ps}*x₂^{p} mod(q) and revert it to entity A. STEP7: Entity A using SK6 eliminates ephemeral {x₂} by computing SK₇=[x₄^{s}*x₃^{ps}*x₂^{p}]^{p}^{^{−1}}*x₂⁻¹ mod(q)=x₄^{p}^{^{−1}}^{s}mod(q) and send it to entity B using which the entity B attains the session key by eliminating ephemeral {x₃} by computing [x₄^{p}^{^{−1}}^{s}*x₃^{s}]^{s}^{^{−1}}*[x₃]⁻¹ mod(q)=x₄^{p}^{^{−1}} mod(q), Since the session key generated consist of ephemeral produced by entity A thus entity A can generate the session key by computing x₄^{p}^{^{−1}} mod(q), where the same has been attained by entity B. Important thing here is to understand that entity A can publish the values from step1-step5 publically before initiating communication and entity B can generate ephemerals such that the result of Step2,Step4 match and using the generated ephemeral entity B can then resume the key exchange protocol from step6 and attain the session key generated by entity A. We propose this scheme be used when user performs login operation at web interface, here once the credentials are validated by the bank server module then the web server module sends validate successful request and initiates the communication with the web interface by sending key exchange request, here the credentials which are provided by the user are used for authenticated key exchange for this the web server module generates a message nonce, timestamp and computes Kₜₑₘₚ₁=h(Nonce,Timestamp,username, password) and this becomes a key which web server module uses for exchanging the information the first exchanged message which is as follows:

SKUM₁=E_{K}_{_{Temp1}} (h(usemame∥Password)∥Nonce∥Timestamp∥SessionID∥Key_{Next})∥h(username∥SK₁∥Timestamp∥SK₂∥K_{Temp1}∥SK₃∥Nonce∥SK₄∥Key_{Next}∥Password∥SK₅∥q∥SessionID)∥mod(q)∥SK₁∥SK₂∥SK₃∥SK₄∥SK₅∥Nonce∥Timestamp

This generated message by the web server module is directed to web interface using which the web interface generates SK₆ and send it in authenticated manner, for this web interface uses Key_{Next} in SKUM₁ and then generates SKUM₂=SessionID∥E_{K}_{_{Next}} (h(usemame∥SessionID∥Password∥SK₆)∥Nonce_{webinter}∥Timestamp_{webinter}∥SK₆∥Key_{webinterer})∥h(username∥Nonce_{webinter}∥password∥Key_{webinter}∥Timestamp_{webinter}∥SK₆∥SessionID) Which is then forwarded to web server module now the web server module performs the the final exchange SKUM₃=SessionID∥E_{Key}_{_{webint er}} (h(SessionID∥username∥Password∥Nonce_{webinter}∥SK₇)∥SessionID∥SK₇) using the attained SK₇ then the web interface performs final step of the key exchange and attains the session key.

US20090172407 Entitled “Virtual smart card system and method” is a granted patent. This patent comprises of an authentication system for authenticating a user. Each user is assigned with a public key and a private key where the private key is included in a virtual smart card assigned to the user. The private key is also associated with a digital signature assigned to the user. An authentication server, host system and a directory service both connected to the authentication server act as a certification authority for the user's digital certificate. The host system consists of a public key authentication client and an interface where the public key authentication client receives a challenge issued to the user from the authentication server, signs it with a digital signature particular to the user and then sends it back to the authentication server. The directory service stores public keys of all users so the authentication server after receiving the challenge signed with the digital signature verifies it with a public key extracted from the directory service. A virtual smart card server with storage and virtual smart card agent both connected to the virtual smart card server authenticate the user to obtain its private key where the storage has virtual smart cards of all the users stored in it. The user encrypts a one-time password with its public key which is sent to the virtual smart card server. The digital certificate of the user is verified that it was issued by a recognized authority and then the encrypted one-time password is decrypted with the private key extracted from the digital certificate. The decrypted one-time password is then matched with the expected one-time password.

98/MUM/2006 Entitled “System for facilitating a payment through a mobile communication device” is a granted patent. This patent provides a method of payment through a mobile communication device with the help of a payment platform Paymate. The system comprises of mobile communication devices with unique identification number of a payer and payee, Paymate which is a mobile payment platform and a debit server which debits the transaction amount from the payer's account and credits it into the payee's account. The payer and payee communicate with the Paymate through SMS. The payee sends the transaction identifier and transaction amount to the Paymate. The payer sends the transaction identifier, transaction amount and PIN. The Paymate verifies the transaction details sent by both the users and then it authenticates the payer through the identification number of its mobile communication device. Once the payer is authenticated it sends a debit request to the debit server to perform the transaction.

WO2009032618 Entitled “Method and system using reloadable portable consumer devices” is a granted patent. This method comprises of a portable consumer device, issuer of the portable consumer device and an ATM which communicated through a payment processing network for initial loading or reloading of the portable consumer device. The user accesses the ATM and provides a tender which sends a transaction authorization request message to the issuer of the portable consumer device which is to be used by a user. The issuer authorizes the transaction authorization request message and then sends a transaction response message back to the ATM which indicates whether the transaction authorization request message was approved or not. If it was approved then the portable consumer device gets initially loaded or reloaded with an amount associated with the tender.

EP1158433 Entitled “Online payment system and merchandizing center” is a granted patent. The patent provides an online payment system comprising of a terminal connected to a network, a merchandizing center connected to a network for selling product to a purchaser and a Computer Telephony Integration (CTI) center which acts as a control station and completes the payment. The CTI can access the account of a purchaser by using a predetermined password and complete the payment after authenticating the purchaser. The terminal of the purchaser connects with the merchandizing center with a telephone line connected to the network and inputs its telephone number through which it is making the call. Then the purchaser orders a product and then the merchandizing center allows the terminal to disconnect from the line it was connected to, so that the terminal gets automatically connected with the merchandizing center with another telephone line which is capable of notifying the merchandizing center of the telephone number of the terminal. If the input telephone number and the telephone number notified to the merchandizing center both match then the merchandizing center accepts the order given by the purchaser. Then the merchandizing center forwards the input telephone number and the purchase price to the CTI. The CTI allows the terminal to disconnect from the current telephone number it is connected to, so that the terminal gets automatically connected with the CTI with another telephone line which notifies the CTI of the telephone number of the terminal. If the notified telephone number and the telephone number provided to CTI by the merchandizing center match then the CTI completes the payment.

### SUMMARY

The main objective of the present invention is to perform banking operation and payment transactions which were performed using physical smart card via a module called virtual smart card(we define our virtual smart card to be a module which is accessed by the interface) and an interface which embeds this module on it and uses it. A virtual smart card emulates a physical smart card in terms of functionality, a virtual smart card comprises of user related credentials such as card number, expiry, CVV, etc and the virtual smart card is embedded on a physical smart device which has some abilities such as capturing a QR code and decoding it, connectivity to a network and have a display unit which can display the QR code on the same. A virtual smart card is used by the user to perform banking operation at kiosk or processing payments, the payments can be made to a merchant or can also be done on the webserver the credentials are provided in such a fashion that no card information is ever exposed to either merchant or ATM units or on the website this brings out a new approach of processing payments as the credentials depicted on the display unit of the device is such that it can only be interpreted by the bank server thus any entity who attains these credentials cannot process the same without the help of bank server, the interface is responsible for accessing the credentials from the virtual smart card and making appropriate messages based on the request directed by the user and representing the same in the form of a QR code on the display unit, even a merchant is in possession of a virtual smart card but this virtual smart is doesn't function as that of a user based virtual smart card as this virtual smart card is only used for accepting payments and displaying on the display unit which is similar to what a card swiping machine does, the merchant virtual smart card is again facilitated by an interface which accesses the credentials of the virtual smart card and generates a random QR code for the amount depicting the credentials for the bank server module and displaying the same on the display unit of the merchant, here the key advantage of merchant virtual smart card is that it can be easily deployed on multiple devices as it can only be used for accepting payment which is directed to virtual smart card (account associated with virtual smart card) of the user who owns the merchant virtual smart card, thus even if credentials associated with merchant virtual smart cards are exposed even then they are of no use to the adversary as these credentials cannot be used for performing banking operations or making payments, the only role of merchant virtual smart card is to facilitate the transaction and accepting payments, important point here is that even user can deploy virtual smart card credentials across multiple devices but the user must be careful while deploying as there can be a malicious access of the credentials of the user. The key benefit of the following invention is that user need not enter card credentials while facilitating online payments or payments to merchant this is very important as the user even if facilitated payment at malicious website even then no user credentials are ever exposed. The transactions are not limited to a single bank server, the communication can take place between different bank servers, the invention thus focuses on seamlessly processing transactions in such a manner that no user associated credentials are ever revealed even at the kiosk (ATM) unit when user is performing operation then the user can either set up a pin or be dependent on an OTP which is sent by the bank server module and displayed in the form of a QR code which can only be interpreted by the user on which virtual smart is embedded and who initiated the communication. We proceed by depicting the same in detailed description and highlight functionality of each module, virtual smart card and an interface which are used for communication.

### BRIEF DESCRIPTION OF DRAWINGS

Although detailed description is presented to understand basic aims and scope of the invention, we would like to highlight that the invention is not bound to just lie in the presented scope, thus not limited to these scopes. This section provides a quick reference and a basic idea about the drawings.

FIG. 1. Shows the broad view of communication between the user and the bank server module with the help of a hardware module and also depicting different associated services.

FIG. 2. Shows the Virtual Smart Card and Interface associated with it and a merchant Virtual Smart Card and merchant Interface associated with it.

FIG. 3, 3a, 3b, 3c. Depicts the flow of communication taking place between the hardware module and bank server module when user provides credentials to performs necessary operations at kiosk unit, we also depict involvement of appropriate services and storage units for the same.

FIG. 4. Depicts broad view of the overall communication taking place between the merchant, user and bank server module for processing a transaction, we also depict involvement of appropriate services and storages.

FIG. 5. Depicts the communication flow between the user and the bank server module when user does online payments.

FIG. 6. Depicts the broad view of communication which takes place when two communicating V.S.C's are from different banks or when hardware module and V.S.C belong to different bank authorities.

### DETAILED DESCRIPTION

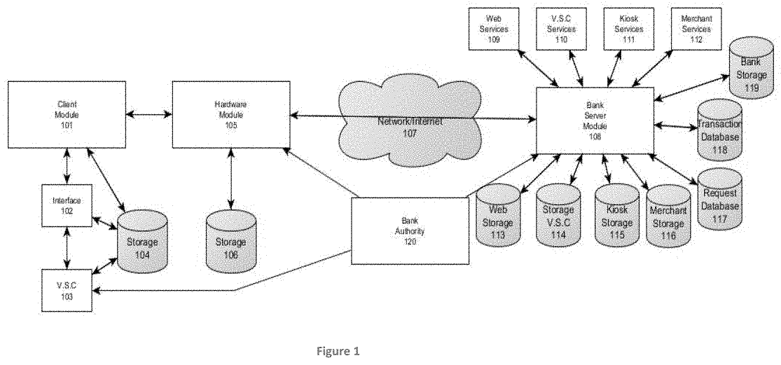

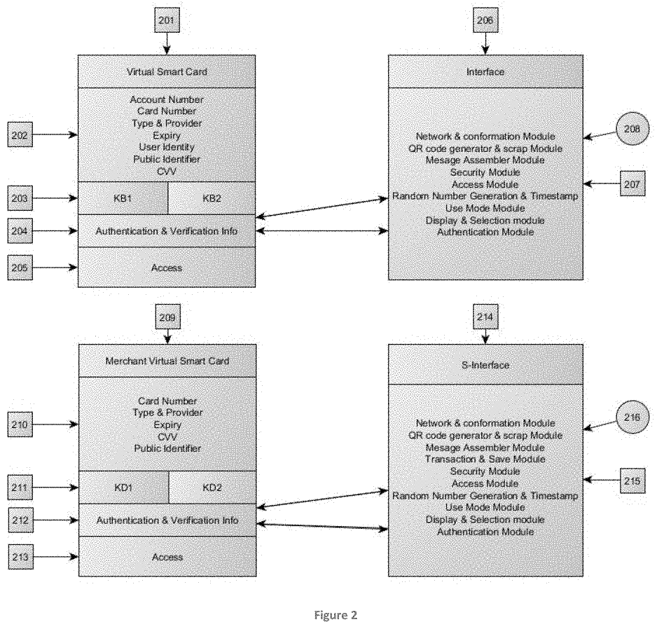

FIG. 1. Depicts broad view of how the communication is initiated between the client module 101 and the bank server module 108 which is facilitated by the hardware module 105 over the network 107, a client module consists of a Virtual Smart Card (V.S.C or VSC) 103 where the V.S.C is embedded on an interface 102 and the interface is embedded on a smart device which constitutes of a client module 101 owned by a user. Here the V.S.C credentials and the associated modules are stored on 104 which can be accessed by the interface and the communication can only be initiated by the interface 102 to these modules to attain the credentials of the V.S.C; moreover two modules are integrated on the V.S.C (described in detail in FIG. 2) such that they prevent malicious access if V.S.C authentication is enabled. V.S.C is stored on a storage unit 104 embodied by the smart device in the client module 101. Here the user wishes to communicate to the bank server module 108 by providing necessary authentication credentials so that the user can perform banking related operation at the hardware module 105 and then the updated credentials be reflected on the transaction database 118 and on appropriate storage units at the bank server module, for this the user accesses the interface 102 which is password protected or protected by some other mode of authentication such as biometric based authentication and the related information associated with the authentication is stored on the storage (usually in a hashed format) and if the stored credentials and the provided credentials match then the interface asks user to select the mode of use (associated with V.S.C) on the interface after which if no authentication is enabled then the interface accesses the credentials which are embedded in the V.S.C 103 which is stored on the storage unit 104 otherwise if the authentication is enabled for the V.S.C then the user must provide the authentication so that interface can access the credentials of the V.S.C after which the interface 102 generates a QR code (encrypted using long term keys between the client and server modules) with the help of V.S.C credentials and the mode of use of the interface, after which the message is directed to the bank server module 108 using the hardware module 105 over a network 107 which is established between the hardware module and the bank server module 108. The hardware module consists of a kiosk unit which scans the QR code (once proper option is selected on the kiosk unit) generated and displayed on the interface 102 of the client module 101 after which the QR code credentials are decoded and then the kiosk unit generates a transaction ID of its own and then accesses the credentials associated of the kiosk unit such as a public identifier and long term keys using which the kiosk unit encrypts and send the credentials to the bank server module 108 over the network 107 once the credentials of the decoded QR code are encrypted. After the credentials are sent then the bank server module attains these credentials and validates them, if the validation is successful then the bank server module extracts information from the message and then accesses the appropriate user 110 and kiosk service 111 and generates a message by appending services and encrypting using appropriate long term keys from user 114 and kiosk storage 115 after which the generated message is sent to kiosk unit and kiosk unit performs necessary operation using the message (intended for user if any, or just performs operation on the basis of service which kiosk unit attains) on the basis of service appended on the message and then performs these services, now if user has enabled PIN then in that case user has to enter a PIN else the bank server module sends OTP in the message which is encrypted using the long term key of the user, the same is displayed in the form of a QR code on the kiosk unit (by appending appropriate service option for kiosk) after which the user scans the QR code using the interface and attains the OTP which is again sent to bank server for validation (If PIN is entered then PIN is sent by encrypting the credentials) and if validation is successful then the bank server module generates the message for kiosk unit associated with the service which the user asked before and then same is sent to kiosk unit after which the kiosk unit then provides the options associated to the service and once the operation request by the user is performed (user has done some operation and once the same is updated on the transaction database and storage then the operation will be performed) then update credentials request is sent to bank server module along with operation detail done by the user and then the same is reflected on request database 117 and then credentials from request database 117 is updated on transaction database 118 and storage unit 114 and confirmation message is sent to kiosk unit 105 associated with the transaction, else failure message is done and operation is not performed otherwise the operation is performed.

Moreover if the request of transaction is stored on the request database 117 and if the further communication is not done within the time interval say ΔT then the request from the request database 117 is updated on the transaction database 118 with the status of inconsistent or incomplete and then the request database associated with that request is deleted, thus preventing malicious use of the credentials, same happens at the interface and at the hardware or web server module.

The merchant storage 116 consists of merchant virtual card credentials on basis of which the bank server module 108 after receiving a payment credentials from the merchant's client module 101, stores it in request database 117 and if the same amount request is attained from the user side then the virtual smart card of the entity is extracted from the storage V.S.C 114 and the virtual smart card credential of the merchant(the bank server module 108 attains information from the merchant storage 116 which tells as of to whom this V.S.C belongs and based on which the credentials are accessed from the V.S.C storage 114) is also extracted from the storage V.S.C 114 and the desired amount is then transferred from the user's account to the merchant's account who owns the merchant V.S.C.

All the service information is stored on bank storage unit 119, so whenever the bank server module has to respond to any request the bank server module attains service information from one of 109-112 and then based on which the bank server module generates a message and reverts back.

Web payments are processed with the help of web services 109 and web storage 113, similarly all the services are performed, we discuss the same in later figures.

Important thing to consider here is that the user as well as merchant based V.S.C's can be deployed on multiple device, but the merchant V.S.C can be used in receive mode only but the user V.S.C can be used in multiple modes, thus the user's must be careful while deploying these cards.

The generated credentials of the interface are stored in the storage unit 104 in an interface accessible form for a time being after which the credentials are scrapped off, same holds for 106,117.

The key advantage here is that without exposing card credentials transaction is made at the kiosk unit, same is done at the web server module.

Bank server modules also have a public identifier and shared long term keys which these entities use for communicating with different bank server module, we depict the same later.

All these entities such as hardware module, V.S.C and bank server module is owned by bank authority 120, here any anomaly takes place then a user can communicate the bank authority 120, again all the V.S.C's and long term keys of both user and merchant are deployed by bank authority 120 and stored on the bank server module 108 at respective storage units, moreover the web server identifiers and kiosk identifiers and also stored along with long term keys on respective storage units.

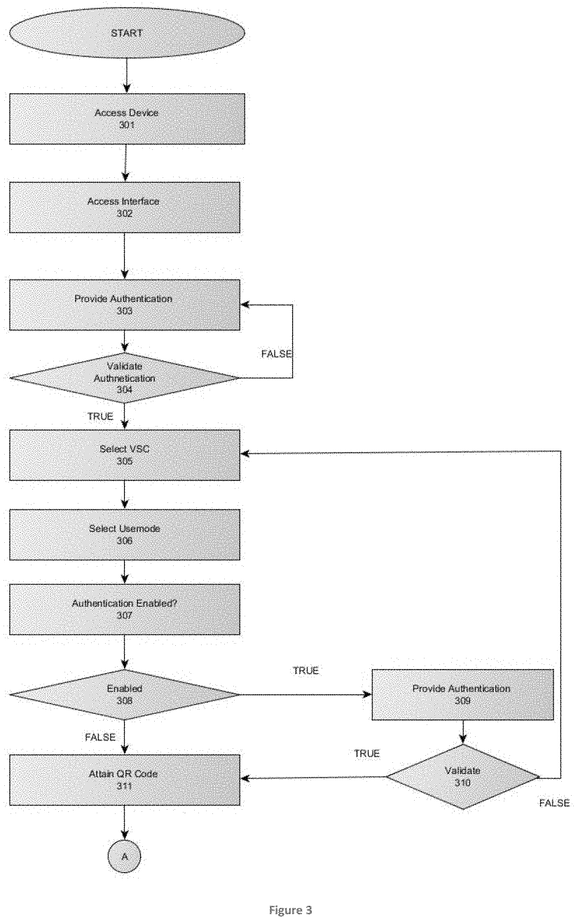

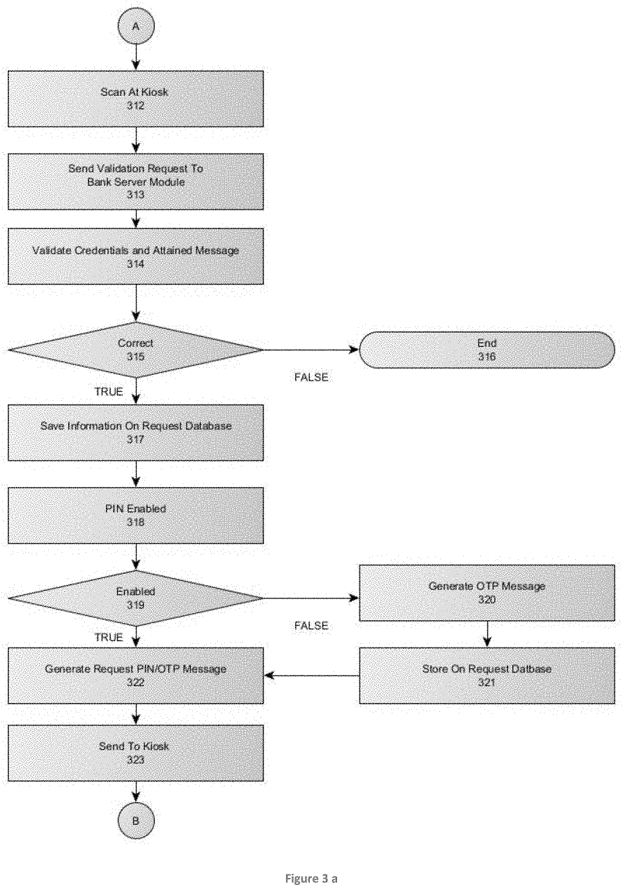

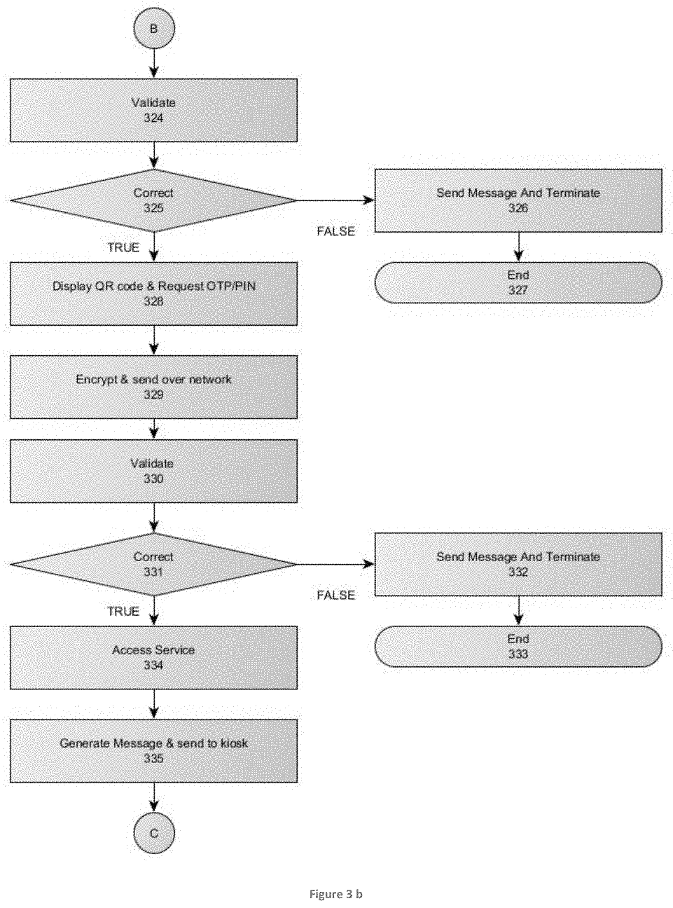

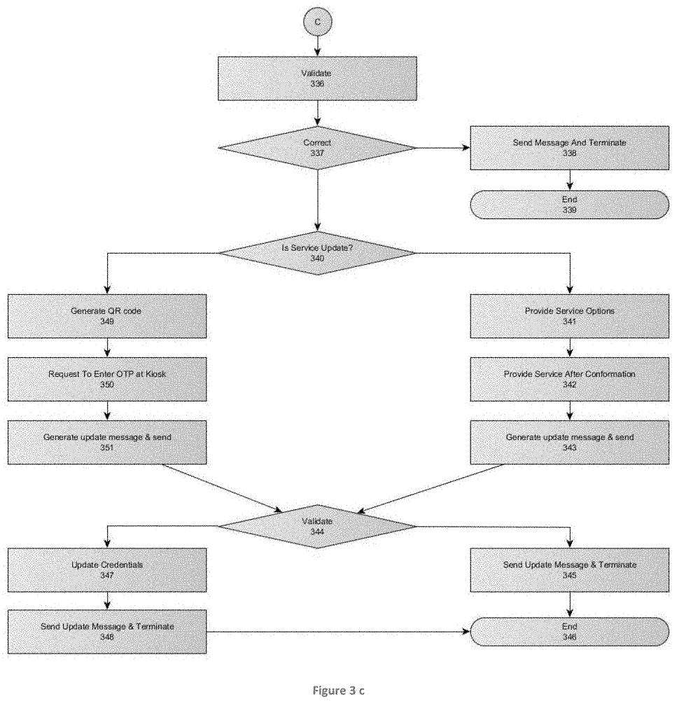

FIG. 2. Depicts the two modules V.S.C 201 and the interface 206 which are used for performing banking related operation at the kiosk(hardware module 105), another pair of modules merchant V.S.C and S-interface is used for initiating payments (FIG. 3 depicts there functioning in detail), and payments are also processed using web server module which we will be discussing in later sections. We proceed by describe the sub-modules and these two modules, first we depict the sub-modules included in the V.S.C after which we proceed by describing the sub-modules in the interface (user, merchant).

A user based V.S.C consists of information such as account number, card number, Type & Provider (What type of card it is and who is the bank which this card belongs to), expiry, CVV number, public identifier, user identity which is represented in 202 and also long term shared key (KB1,KB2) represented as 203, all these credentials are embedded on the V.S.C 202 consists of all card related information whereas 203 consists of all the long term shared keys (KB1,KB2) and the sub-module 204 is where the request is forwarded by the V.S.C which is attained from the interface to access the credentials of 202,203 and if the authentication is enabled then the user is required to provide appropriate authentication to access the credentials of the V.S.C. Once the entered credentials are validated by the authentication & verification info module 204 then this module sets access module 205 to enable and thus the access module 205 provides the credentials of 202,203 to authentication & verification info module which forwards the same to access module of the interface.

The user V.S.C cannot be used in receive mode(depicted later in the interface module), whereas the merchant V.S.C can only be used in receive mode.

Merchant V.S.C 209 comprises of public identifier, Card Number, Type & Provider, Expiry, CVV of the merchant V.S.C (all the credentials are different from the user V.S.C) 210 and long term shared keys (KD1, KD2 211) between the bank server module and the merchant V.S.C credentials are stored on the merchant storage 116 and on the device where merchant interface is integrated, Whereas the functionality of authentication & verification info module 212 and access module 213 remains the same.

There are two different types of interface one for user based V.S.C 201 and other for merchant based V.S.C 209 we proceed by describing user based interface 206 in detail and highlight as of where there exists module deviation between the user based interface 206 and merchant based interface 214.

The interface has several inbuilt module such as QR code generation 86 scrap module, Message assembler module, security module, access module, Random number generation and Timestamp module, use mode module (pay, receive, Banking operation, update, web payment), display and selection module, Transaction & save module, authentication module 207,215. Here each interface has a clock 208,216 which scraps the credentials from the respective storage unit once the clock 208,216 runs out, Each module plays a unique role and helps in generating a message which is then given to QR code generator & scrap module or to network or interface layer or to both of these modules. We now proceed by describing each module in detail and explain the role of each module and how each module communicates with each other for generating a final message which is then used for communication by the user.

Authentication Module is responsible for requesting authentication and authenticating the user at different levels and providing further access only if the authentication is successful, this module also sets up authentication for the interface and also for the V.S.C when accessed for the first time, The authentication credentials associated with interface are stored on the storage 104 of the user's smart device 101 usually in a hashed form so that no useful information associated with these authentication credentials are lost. This module is also responsible for setting up authentication for V.S.C if the user desires (thus up to a user), meaning if the user enables the authentication and provides a desired value of authentication the same is stored (in hashed format) on 204 or 212 and now whenever the user desires to access the interface the user must now provide authentication for interface for accessing the interface in order to perform a given task and must provide authentication for V.S.C so that interface can use its credentials to generate appropriate message. The authentication related information for the interface is stored in hashed form on the storage 104 in a format accessible by the interface, whereas for V.S.C the value is stored on 204 or 212 in the hashed form and the verification request (when the interface tries to access the credentials of V.S.C the request is sent to V.S.C but directed to this module 204, and if the values match then this module provides the credential to the interface and then interface generates appropriate message) is sent to 204 or 212, these modules are present on both the interfaces i.e user based and merchant based interface 206,214 and also on merchant and user based V.S.C's. Moreover the authentication values can also be changed using the interface by accessing appropriate options, which will reflect the changed value on either the storage unit 104 or on 204.

Display and selection module is a part of the interface 207 or 215 which displays all the available V.S.C on the storage 104 as depicted earlier; each V.S.C has a name provided by the bank authority when provided to the user, thus on basis of this the interface 207 or 215 displays it on this module so that the user can identify and differentiate the V.S.C and select from the list of the available V.S.C's on the storage 104. For both the interfaces same functionality is provided, this module is also responsible for displaying any information on the interface 207 such as QR code, O.T.P (one time password), validation or confirmation message and transaction information, we will discuss them in detail in later modules.

Use mode module in 207 or 215 describes the mode of use of virtual smart card 201 or merchant based virtual smart card 209. The user based V.S.C can be used for making payments or performing banking related operation (deposit, withdraw, setting up PIN or changing PIN) at the kiosk unit (hardware module 105) or update, scan mode or web payment mode, we now proceed by giving a broad view of what each of the mode depicts.

Here in the use mode module 207,215 for payment (merchant based) the user is required to scan the QR code generated by the merchant interface, whereas for banking operation the user selects banking operation at the interface and based on which the use mode module appends the appropriate request to the request message such that bank server module can interpret the request and provide necessary services (we will discuss the same later) to the user, the update mode is used when the user desires to change the credentials of the virtual smart card which the user owns due to security reasons or the card is expired, in either case when a change of credentials of V.S.C is required the interface must be used in update under use mode module, if payments are made on web then the user is required to select web payment as use mode (its functioning is discussed later). If a user owns a merchant based V.S.C 209 then any update in the credentials of the user's V.S.C 201 need not be reflected on the merchant based V.S.C 209 as these two credentials are independent of each other and the public identifier information 202 still remains the same for the user.

The merchant's interface 214 which employees merchant V.S.C 209 can only be used in receive mode where the merchant's interface generates a QR code associated with the transaction and the user is required to scan the QR code using the user based interface 206 in the scan mode (use mode). No banking related transaction or update transaction can be performed using the merchant based interface; in general the merchant based V.S.C 209 can only be used for receiving payments from the user thus can be deployed across multiple devices. Once the card expires it can no longer be used, thus new merchant V.S.C must be requested and updated across multiple devices.

Use mode information provides information to the message assembler and other modules as of what information must be present on the final message or the generated message, thus based on this use mode information only the final message is generated and modules used under different use modes vary.

Random Number and Timestamp module in 207 or 215 is responsible for making sure that the QR code credentials are constantly changing; the Random number acts as an OTP (sent from user or merchant's side to the bank server module) which is used to authenticate the request and Timestamp is used to make sure that the QR code is valid, if the time at which the QR code (credentials) is received at the bank server module 108 is greater than a threshold time ΔT then the request is not processed as the QR code is no longer valid. This module is again common for both the interface as random numbers and timestamps are required to authenticate the requests and prevent various wicked attacks such as replay attack.

The access mode provides access to the security module of the long term key KB1, KB2 203 or KD1, KD2 211 and also other credentials stored in the V.S.C 202 or 210 through authentication 86 verification info module 204 or 212. We depict the role of this module in both the V.S.C's and that of the interface.

Access module at the V.S.C (for both merchant and user based) is responsible for not allowing malicious access to the credentials of the V.S.C, the access module when set to disable will not allow the interface or any application to access the credentials from the V.S.C, for this the access module must be set to enable by either providing appropriate authentication to authentication 86 verification module 204,212 if set or requesting the module to enable the access if no authentication is set, if authentication is enabled and once the correct authentication is provided then this module is set to enable and the authentication & verification info module is able to access the credentials of the V.S.C, else will not be able to. We will discuss about the same later.

Access module in the interface 207,215 attains information from the network & confirmation module, here as soon as the message is attained at network & confirmation module the message credentials are directed to this module from where this module accesses the V.S.C credentials such as long term keys and sends it to security module along with the attained credentials to decrypt the message and attain appropriate credentials. This functionality is common for both of the user based and merchant based interface, now we depict for the V.S.C's, this module is also used for attaining credentials from the QR code once scanned thus is responsible for decoding the QR code and then sending to the appropriate module.

Security module performs cryptographic operations for instance encryption, decryption, hashing (message authenticators). This module discards the received messages which do not match the validation requirements by displaying appropriate message at the display & selection module 207, whereas if the validation matches then this module directs the result along with credentials to appropriate module. We now proceed by depicting this modules role in both user and merchant based interfaces 206,214.

User based interface 206 uses this module based on the mode of use of the interface (use mode) if the use mode is any of the banking related operation then the security module is used to generate encrypted message using credentials provided by the other modules such as timestamp and random number module provide timestamp and a nonce which is then fed to this module along with use mode information and the access module fetches the credentials associated with the V.S.C from the authentication 86 verification info module 204 and feeds this information to this module. There are two encrypted messages which are generated by this module and fed to message assembler module 207 which performs its operation and generates the final message which is then displayed in the form of a QR code at the interface with the help of display 86 selection module (for banking operation use mode), whereas if the use mode is send mode then the user scans the QR code displayed on the merchant's interface and then the credentials are accessed by the access module which decodes the QR code and sends appropriate information such as user's V.S.C credentials and long term keys to this module and then the interface encrypts the decoded credentials by appending use mode information, timestamp and random number and then generates an encrypted message and forwards the same to message assembler module which then forwards the same to network & confirmation module which performs necessary operations if the user validates the transaction amount, else all the credentials are scrapped out. If the use mode is update then this module just verifies the attained message and if the verification holds then the credentials are updated else the error message is displayed on the interface with the help of display & selection module, whereas if the use mode is web payment then again QR code is generated similar to that of when banking related operations was chosen under use mode (we will discuss the same later).

Merchant based interface 214 uses this module for generating a transaction based encrypted credentials and forwards the same credentials to the bank server module so that user can make the payment for the transaction. For this the merchant accesses the V.S.C in receive mode and enters the amount which the merchant desires (can again be automated) and then generates the encrypted message using this module and then the QR code is displayed on the screen associated with the credentials and same credentials are then sent to bank server module over the network so that when the user sends the payment information to the bank server module the transaction is processed and is successful.

Important thing to highlight here is that user based interface and V.S.C 206, 201 cannot be used in receive mode and merchant based V.S.C 209 and interface 214 can only be used in receive mode and hardware and web server module just need to keep track of their public identifier and long term shared key which they possess and is usually stored on the storage unit associated with these modules.

Transaction & Save module is available only on merchant interface 214, this module generates a random transaction ID for the payment and then forwards the same to message assembler, this information is appended along with public identifier thus this information is not encrypted and when the user scans the QR code the user can see this information along with that of amount and public identifier of the merchant V.S.C. This step is really important, if any inconsistencies take place when transaction was processed then this information gives the user information to communicate with bank authority so that transaction amount be reverted back. The save part of this modules comes into picture when the merchant receives the transaction confirmation or rejection from the bank server module, the request of extracted credential is sent to this module (along with other modules) so that merchant can save the information associated with transaction on the device, thus the save part of this module saves the transaction related information on the storage of the merchant's device.

Message Assembler is used to assemble the overall message, and is common for both the interfaces 206,214.

Message assembler 207,215 takes the message input from the security module 207,215 which provides two encrypted messages and then user's public identifier information is accessed from the V.S.C with the help of access module (interface) 207,215 and then all the message credentials are combined and generated as a whole, this module waits till all the credentials are available and the message is assembled and once the message is assembled then the final message is directed to either QR code generator 86 scrap module or network 86 confirmation module or both based on need. Thus this module waits till the message from all the other module has arrived (this information is provided by use mode information) and once it did then feeds as input to other modules so that there is no loss of information and complete message is generated and sent to respective modules.

QR code generator and scarp module displays the QR code of the information which is provided by message assembler module 207,215, and sets the access module of the V.S.C to disable once the credentials of V.S.C are used and the timer 208,216 runs out.

For user based interface 206 this module is used for generating a QR code comprising of user based credentials and the services which the user desires to perform at the kiosk unit so that bank server module can validate the user and then provide the services the user desires to perform at the kiosk. Thus this module displays the information comprising of user's credentials and the use mode information (in encrypted form) which the user desired to use the V.S.C in, and once the QR code is displayed on the interface with the help of display & selection module then the user can perform desired operation using the QR code, this module is also used to scrap the generated QR code, it is important to prevent malicious access and use of the QR code, for this a timer is attached to this module and as soon as the message is received (by message assembler module) at this module a timer is started and as soon as the timer hit the set time (of a specific predefined time) then the QR code will no longer be displayed on the screen and the credentials which were used to generate the QR code will be scrapped from the storage and the request to V.S.C will be sent to set the access module of V.S.C to disable (it was set to enable earlier so that the interface could access the credentials of the V.S.C) so that no malicious access of V.S.C credentials will be allowed. Thus this module plays a vital role as it prevents malicious access of the credentials of the V.S.C and also scraps the credentials of the QR code when the timer runs out.

When the user accesses the interface in web payment mode even then QR code credentials are generated and process is carried out but instead of kiosk unit there is a presence of web server module which facilitates the payments in such a fashion that there is no need for user to provide card details for processing the payment, for this to happen user must be in possession of two devices such that one device accesses the web interface and other is used to reflect the QR code and now using the device which has generated the QR code the user places the displayed QR code in front of the device which accesses the web interface such that the web interface accesses the QR code and decodes the credentials and then send it to bank server module, after which the bank server module validates the credentials and send appropriate message to web server module after which if the credentials are validated then the web server module then generates a message of payment and send it to both web interface and the bank server module, after which the user accessing the web interface scans the QR code displayed on the interface with the help of the other device (on which V.S.C and interface is embedded) and if user validates the payment amount and its credentials then the same request is directed by the user to the bank server module and if both are successful then the bank server module completes the transaction and reverts the confirmation message to both the entities.

For merchant based interface this module is used for attaining the payments from the user, the QR code 86 scrap module works in the similar fashion which we depicted earlier for user based but here user's credentials are not used but rather credentials from 210 is used to generate the message the QR code comprises of Amount, Transaction ID, Public identifier of the merchant, Encrypted transaction based information for the bank server, so that bank server module can store the information on the request database and proceed further once the request from the user is attained. Again once the timer is up the QR code credentials are scrapped from the storage unit and access module of the merchant V.S.C is set to disable.

Network & Confirmation Module 207,215 is used for sending and receiving information from the bank server module over the network, the information sent comprises of transaction based information which is to be processed for making payments by the merchants and users; once sent then this module is used to receive the status information from the bank server module after the transaction is processed, whose credentials are accessed by the access module.

For merchant based interface 214 this module is used to send the request of payment by validating the amount for this once the message is generated the amount is displayed on the merchant's interface with the help of display & selection module then the merchant is required to validate the payment (by selecting appropriate option displayed on the display & selection module) and if the payment is validated then the credentials are sent to bank server module and the QR code is also displayed on the interface, the credentials of the sent message comprises of information from the message assembler (such as amount, transaction Id, IP address, public identifier of the merchant and encrypted credentials associated with the transaction amount and other credentials) so that the bank server module can store the same in request database and send the transaction status information whether the transaction was successful or not which is again received by this module and then sent to access module so that access module can attain information from the message and then feed it to appropriate module for extracting the information and displaying on the screen. This module is responsible for any network related activity which may be performed and moreover it provides IP Address of the device to the bank server module (the IP address is a part of the generated message which is sent to the bank server module), same is done in user based interface.

For user based interface 206 this module is used to send request of the payment which the user attained by scanning the QR code at the interface of the merchant's smart device or at the web server interface after which the credentials are then encrypted by adding appropriate identifiers so that bank server module can identify as of which user desires to make payment and of what amount, and then the encrypted message is sent to the bank server module once the user validates the payment for this the amount information is shown on the interface with the help of display & selection module and the user is required to validate the payment by selecting to pay or reject the transaction amount. If the user selects the pay option then the encrypted information attained from the message assembler module is then sent over the network to the bank server module and then bank server module reverts back with appropriate message (encrypted) informing the user as of what is the status of the payment, once the message is received at this module the proper credentials are accessed by the access module and directed to appropriate module and finally displayed on the interface with the help of display & selection module. We will discuss the same later.

If web server interface is used then the user scans the QR code displayed on the web server interface and then as specified earlier same process is done as of what happens when the user accesses the interface in scan mode and then the credentials are sent to bank server module if the user validates the amount, after which confirmation is received at this module and is forwarded to appropriate module.

Authentication & verification info module in 207,215 is used to prevent malicious access of the credentials of the V.S.C 201,209 by requesting authentication and validating it if the authentication is enabled by the user of the interface or else the module is used to provide access directly to the interface, this module is common for both the V.S.C's.

For user and merchant based V.S.C's 201 or 209 the functionality of this module remains the same, the access module sends request to V.S.C to provide the credentials of 202 or 210 and then this module checks if authentication is set for this module; if so then the authentication request is diverted to authentication module 207 or 215 at the interface where now the user must provide valid authentication and the input value is hashed and sent to this module and then this module checks if the provided value is correct, if so then this module sets the access module of the V.S.C to enable and then reverts back with the credentials in 202 to access module in the interface. If the authentication is not set for this module then this module is blank and when the access module of the interface sends request to this module then this modules sets the access module of the V.S.C to enable and reverts back with the credentials in 202 to access module in the interface.

Here each module provides a particular service which any other module can use and then based on the use mode information or which module is requesting which service and is there any redirect request, if exists then the output is redirected to that module else the output is redirected to the module from which the request has come.

Here the kiosk or V.S.C services or web service depict the interface or the kiosk unit as of what operation needs to be performed so that proper functioning can be done and whenever any operation is requested, they are usually done by communicating with different modules of the interface and the V.S.C for user and with the storage for the kiosk and web server module, Thus information associated with the V.S.C services is also stored on the storage unit 104 thus whenever the access module 207 attains any information associated with the V.S.C services the access module 207 attains information from the storage unit (usually stored in the form which can be accessed by the interface and in read mode only) 104 and then direct the attained credentials to appropriate module, moreover for the interface this information is useful as based on this information only, the modules interpret as of where the request needs to directed (redirect request) and what needs to be done after that. Usually access modules attains information from the V.S.C services (stored on the storage unit 104) and the messages and directs the request to other module (of the interface and the V.S.C) and inform other module as of where the attained credentials need to be sent and what operations to perform for other module using these information.

User can view credentials of V.S.C by selecting option of view as use mode at the interface, thus the credentials of the V.S.C excluding 203 will be displayed on the display & selection module, whereas only the expiry information will be depicted on the display & selection module in case of merchant interface.

FIG. 3,3a,3b,3c. Depicts as of how a user can perform banking operation at kiosk using the smart device on which the user based V.S.C and interface is embedded.

User accesses the interface 302 by accessing the smart device 301 which the user owns after which the authentication module 207 of the interface requests the user to provide authentication 303 to proceed further, which as depicted can be either a password, biometric or any other form such as facial recognition, voice, etc. Once the user provides authentication the authentication module 207 of the interface passes this information to security module and attains the hashed nature of the input credentials after which this module verifies the input credentials with the stored credentials on the storage unit 104 and if the credentials match then validate authentication 304 is true else it false, and if the validate credentials does not hold then the user is redirected to 303 till a valid response is attained, whereas if 304 is true then the user is directed to select a V.S.C (as depicted each VSC module has a name associated with it, on basis of this user differentiates between the cards) using which the user desires to perform banking operation, each card is uniquely identified by a user on the basis of a name (already stored on the storage unit 104 when the V.S.C was accessed for the first time and stored at the same place where the V.S.C module is present) which the interface displays using the display & selection module 207, after which the user selects from the list of available V.S.C's 305 and then selects the mode in which the user desires to use the V.S.C for instance withdraw, deposit, balance enquiry, service registration, or any other operation which the user desires to perform at the kiosk (all of these fall under banking operation). Once the user selects these information, in the background the interface generates a random number and a timestamp (these credentials are sent to security module) which will be appended to the message once the credentials of V.S.C have been attained, in the meantime the interface tries to access the credentials of the V.S.C for this the interface directs the request to the V.S.C module where the request received by this module is redirected to authentication & verification info module (which is the sub-module of the V.S.C) 204 after which this modules checks if the authentication is enabled 307 and if the authentication is enabled 308 then this module directs the request of providing authentication to the authentication module 207 of the interface, after which the user is required to provide authentication for the same 309 and then the authentication module sends the input credentials provided by the interface to the security module 207 which returns the hashed value of the input credentials to authentication module 207 which redirects the attained information to V.S.C which redirects it to authentication & verification info module 204 which then compares the stored value in this module with the received value and if the received credentials do not match then the V.S.C does not provide access to the access module of the interface thus the interface redirects the user to again select from list of available V.S.C's 305, whereas if the credentials are correct i.e 310 is true or no authentication was enabled (308 is FALSE) then the authentication & verification info module 204 sets the access module 205 of the V.S.C to enable (till the QR code & scrap module discards the connection) which fetches the credentials from 202 and provides the same to 204 after which the access & verification module then sends these information to access module of the interface where this module sends the attained information to security module 207 and then using the credentials which the security module attained such as random number and timestamp, use mode information and V.S.C credentials, the security module then proceeds by generating encrypted credentials, we now depict the motivation behind generating the message at this module using the above said information which comprises of step 311.

Before specifying what message is generated by security module we depict the main motivation for generating the message at security module, for this we had few criteria's such as the generated message should be in such a manner that user identity and credentials are never revealed even if long term keys are compromised, moreover there must exist a public identifier on basis of which only the bank server module can interpret the true identity of the user, this will play a very important role as the user identity is not revealed and moreover the credentials will be generated such that no useful information associated with the user is ever lost. The message generated below is an example which depicts as of how the communication will take place, we would like to put emphasis on the fact that the representation of generated messages are one of the total possible ways, there can be many others. We provide the same so that it provides an idea to the reader as of how the messages can be sent.

We now depict the message which the security module generates and sends to message assembler module. Initially all the hashed credentials are generated such that they comprise of all the credentials associated with use mode, random number and all the information is fed to the security module in such a way that no useful information is known by interpreting the message directly, the following are hashed information which is generated.

I:h(Nonceᵤₛₑᵣ∥IDᵤₛₑᵣ∥K_{B1}∥Timestampᵤₛₑᵣ∥Expiry∥AccountNumber∥Use mod e_{Credentials}∥CVV) and then the second hashed information is generated as follows

II:h(CardNumber∥Use mod e_{Credentials}∥K_{B2}∥Type & Provider∥IDᵤₛₑᵣ∥Timestaᵤₛₑᵣ∥PublicIdentifierᵤₛₑᵣ) once these credentials are generated then the security module encrypts the generated credentials so that even hashed credentials are unknown, for this following are the encrypted credentials which are generated.

I:E_{K}_{_{B2}} (Timestampᵤₛₑᵣ∥I), II′:E_{KB1}(Nonceᵤₛₑᵣ∥II) and then this module proceeds by combining the encrypted credentials and generate final two encrypted blocks.

E_{K}_{_{B1}} (PublicIdentifierᵤₛₑᵣ∥I′∥Nonceᵤₛₑᵣ), E_{K}_{_{B2}} (Timestampᵤₛₑᵣ∥II′∥Use mod e_{Credentials}) and then send it to the message assembler module which then combines all the messages and generates a final message by requesting access module to provide user's public identifier details so that the identifier can be appended and bank module can interpret the identity of the user who wishes to communicate, This is the final message which is generated by message assembler module:

M₁:PublicIdentifierᵤₛₑᵣ∥E_{K}_{_{B1}} (PublicIdentifierᵤₛₑᵣ∥I′∥Nonceᵤₛₑᵣ)∥E_{K}_{_{B2}}(Timestampᵤₛₑᵣ∥II′∥Use mod e_{Credentials})

The generated message is then forwarded to QR code generation & scrap module 207 which sets the timer 206 as soon as the credentials are received at this module after which displays the attained information in the form of the QR code on the interface with the help of display & selection module, this step comprises of step 311 and once the QR code is generated then the QR code is placed at the kiosk unit such that the kiosk unit is able to capture the QR code generated by the user's interface 312 after which the QR code credentials are attained by the kiosk unit by decoding the QR code which this kiosk unit captured then the credentials from the QR code are extracted i.e M₁ is extracted. Here once the credentials are extracted then the kiosk unit 105 encrypts the message M₁ and then forwards the attained credentials to the bank server module 108, for this the kiosk unit extracts two information i.e the long term shared keys(K_{C1}, K_{C2}) and the public identifier information from the kiosk storage 106 and then generates the following message.

III:h(Nonceₖᵢₒₛₖ∥M₁∥K_{C2}∥Identityₖᵢₒₛₖ∥IPₖᵢₒₛₖ), IV:h(PublicIdentifierₖᵢₒₛₖ∥Timestampₖᵢₒₛₖ∥IPₖᵢₒₛₖ∥M₁∥K_{C1}) followed by III′:E_{K}_{_{C1}} (Timestampₖᵢₒₛₖ∥M₁∥III∥IPₖᵢₒₛₖ), IV′:E_{K}_{_{C2}} (Nonceₖᵢₒₛₖ∥IPₖᵢₒₛₖ∥IV∥M₁) which leads the kiosk to generate the final message by appending the public identifier information to the encrypted credentials i.e PublicIdentifierₖᵢₒₛₖ∥III′∥IV′ and then send this information over the network to the bank server module 313 for validation. Here IP Address of kiosk is appended so that the bank server module can direct any message which the bank server module generates to the IP address.

Once the bank server module 108 receives the message from the kiosk unit, the bank server module 108 identifies the kiosk unit on the basis of the public identifier on the message which the bank server module 108 received from the kiosk using this information the bank server module extracts the long term shared key associated with the public identifier information on the kiosk storage 113 after which the bank server module decrypts the message i.e III′, IV′ is decrypted using K_{C1},K_{C2} after which the bank server module extracts information such as Nonceₖᵢₒₛₖ, Timestampₖᵢₒₛₖ and first verifies the freshness of the message i.e the difference between the timestamps of when the message was arrived at the bank server module and timestamp in the message and if the difference is less than some threshold ΔT≤X then the message is extracted and then the bank server module compute III*, IV* of its own using the credentials of the user(card number, expiry, etc) and from the attained message, once computed then these credentials are validated 314, for this if the generated values are not equal i.e III*?III, IV*?IV does not hold (315 fails) then the bank server module generates a transaction ID and stores the status of the transaction(invalid PIN, credentials or invalid message if ΔT≤X does not hold) on the transaction database(along with kiosk public identity) 115 as invalid request then the bank server module terminates the request, now since the kiosk unit will not receive any message in ΔT time then the kiosk unit will also terminate the request by depicting the error in communication message on the kiosk unit 316, once the validation holds for all I, II, III, IV (Bank server module computes all I*, II*, III*, IV* and all of I?*, II?II*, III?III*, IV?* holds) then 315 is True and the bank server module generates a transaction ID and accesses the use mode credentials from M₁ and saves the same on the request database (comprises of nonces and timestamps generated by both user and kiosk unit, etc) along with the transaction ID generated by bank server module and also kiosk identifier, after which the bank server accesses the storage V.S.C (associated with the user) 114 and then checks if PIN is enabled 318 for the V.S.C and if PIN is not enabled i.e 319 is FALSE then the bank server module 108 generates an OTP 320 which the bank server module appends on the request database 321 associated with the same transaction ID after which the bank server generates a request message for the kiosk unit by appending appropriate services, same happens if PIN is enabled but now the service will be accessed which request the user to provide PIN. Bank server module generates a message first using the V.S.C service (it informs the access module as of what service needs to be performed with the message given, and then the access module provides all the required services by accessing the information associated with the service from the storage unit) and kiosk service informs the kiosk unit as of what operation has to be done with the received message or what services are to be provided. The generated message comprises of all the related information associated with both the user and kiosk on the request database, The generated message (when OTP is to be sent) is constructed as follows:

V:h(Nonceᵤₛₑᵣ∥IDᵤₛₑᵣ∥Nonce_{bankserver}∥Timestampᵤₛₑᵣ∥K_{B1}∥Expiry∥AccountNumber∥UserUse mod e_{credential}∥CVV∥V.S.C_{service}∥TransactionID), VI:h(CardNumber∥UserUse mod e_{credential}∥Timestamp_{bankserver}∥V.S.C_{service}∥Nonceᵤₛₑᵣ∥TransactionID∥K_{B2}∥Type & Provider∥IDᵤₛₑᵣ∥Timestmampᵤₛₑᵣ∥PublicIdentifierᵤₛₑᵣ)

using both V,VI bank server module generates V′:E_{K}_{_{B2}} (Timestamp_{bankserver}∥V∥TransactionID), VI′:E_{K}_{_{B1}} (Nonce_{bankserver}∥TransactionID∥VI) and then generate the final message

M₂=PublicIdentifierᵤₛₑᵣ∥E_{K}_{_{B1}} (h(Nonce_{bankserver}∥IDᵤₛₑᵣ∥VI′)∥V′∥Nonceᵤₛₑᵣ∥V.S.C_{service}∥PublicIdentifierᵤₛₑᵣ)∥E_{K}_{_{B2}} (h(Timestamp_{bankserver}∥V′∥UserUse mode e_{credential}∥V.S.C_{service}∥VI′∥Timestampᵤₛₑᵣ∥UserUse mod e_{credential}∥V.S.C_{service})

The appended V.S.C service provides appropriate direction for the interface to perform using the attained credentials (which will be displayed on the kiosk unit, this happens if PIN is not enabled). Now the bank server extracts kiosk service which directs the kiosk unit to perform the desired operation with the received message for this the bank server module generates a message and appends appropriate kiosk service thus the generated message is as follows:

VII:h(Nonce_{bankserver}∥M₂∥K_{C2}∥Identityₖᵢₒₛₖ∥Kiosk_{service}∥Timestampₖᵢₒₛₖ∥TransactionID),

VIII:h(PublicIdentifierₖᵢₒₛₖ∥Timestamp_{bankserver}∥M₂∥K_{C1}∥Kiosk_{service}∥TransactionID∥Nonceₖᵢₒₛₖ)

Using which the bank server module generates the following:

VII′: E_{K}_{_{C1}} (Timestamp_{bankserver}∥M₂∥VIII ∥Kiosk_{service}∥TransactionID), VIII′:E_{K}_{_{C2}} (Nonce_{bankserver}∥VII∥M₂∥TransactionID∥Kiosk_{Service})

which then leads to generation of final message which comprises of public identifier of the kiosk unit appended, thus the final generated message is PublicIdentifierₖᵢₒₛₖ∥VII′∥VIII′ and then revert back to the kiosk unit 323 on the basis of IP address which the bank server module received from the kiosk unit in the message III′, IV′ after which the kiosk unit validates the attained credentials(few of which are from) in III′, IV′ and if validation fails i.e 325 is FALSE then the kiosk unit terminates the connection and displays error on the screen after sending terminate connection request to bank server module the message is generated similar to that of III′, IV′ but here PublicIdentifierₖᵢₒₛₖ∥V′∥VI′ which comprises of message M₃ which is a termination request initiated by the kiosk unit, this request is sent to bank server module which again validates V′, VI′ and if the validation is successful then the bank server module attains the public identifier information and if there exists any request in the request database then that request is terminated by updating the request database status as inconsistent and update the same on transaction database after which the contents are scrapped off from the request database 327, else the message is discarded by the bank server module and as depicted earlier that if no successful message is attained within ΔT time then the bank server module or kiosk unit will terminate the request 327. If 325 is correct then the kiosk unit extracts the attained message and accesses the kiosk service information (in this case display in QR code) and then displays the QR code i.e the message M₂ on the kiosk unit in the form of a QR code. If PIN is enabled the kiosk service comprises of request PIN and M₂is generated of all 0's of equal size as that of size of M₂ when OTP message is generated. If a QR code is displayed then the user is required to scan the QR code using the interface in scan mode after which the interface then accesses the stored credentials which the interface generated earlier (Nonce, timestamp) and access the credentials of V.S.C (as still the clock timer has not been completed thus access module of the V.S.C is still enabled) with the help of access module of the interface, after which all these credentials are directed to security module of the interface which validates the credentials in the attained message (using similar approach as before) and if validation holds then the interface i.e security module extracts the Nonce_{bankserver} and forwards the same on the display & selection module which displays the same on the interface, whereas if the validation fails then the security module sends nothing and nothing is displayed on the interface thus user cannot enter the OTP, and since the kiosk unit will not receive any response from the user then the kiosk unit will send termination message to the bank server module and then the bank server will terminate the request if validation is successful else if it is invalid then automatically after ΔT time the request will be terminated by bank server module. Since the validation was successful then the user is required to enter the OTP which was attained at the interface, in the case of PIN no QR code is displayed on the interface and user is required to enter the PIN in both the case once the user enters the credentials 328 then kiosk unit encrypts the entered OTP or PIN and generates the message, the generated message is as follows:

IX:h(PIN/OTP∥IDₖᵢₒₛₖ∥IPₖᵢₒₛₖ∥Timestampₖᵢₒₛₖ∥K_{C1}∥Nonce_{bankserver}∥Kiosk_{service}∥TransactionID)

X:h(PublicIdentifierₖᵢₒₛₖ∥Timestamp_{bankserver}∥Nonceₖᵢₒₛₖ∥PIN/OTP∥TransactionID∥K_{C2})

Using which the kiosk unit generates

IX′:E_{K}_{_{C2}} (IX∥Kiosk_{service}∥OTP/0's∥Timestampₖᵢₒₛₖ∥IPₖᵢₒₛₖ∥TransactionID),

X′:E_{K}_{_{C1}} (X∥Nonceₖᵢₒₛₖ∥IPₖᵢₒₛₖ∥TransactionID∥Kiosk_{service}∥OTP/0's) here if PIN (included in hash but not in encrypted part) is enabled then all the values are 0's otherwise OTP which the user entered is present there and also the Kiosk_{service} depicts the service which the kiosk unit requires (as depicted earlier that all these information are stored on the storage unit of the kiosk) from the bank server module and now the kiosk unit generates the final message which is PublicIdentifierₖᵢₒₛₖ∥IX′∥X′ and send it to bank server module 329, here once the bank server attains the message then the bank server module first validates the credentials 330 and then validates (as kiosk service depicts the same) the PIN (stored on storage V.S.C) or OTP (which is stored on the request database) after which if 331 is FALSE i.e validation fails then the bank server module generates termination message and perform operations as depicted earlier 332 and then terminates the request for the transaction ID, whereas if 331 is TRUE i.e validation holds then the bank server module access the service from the request database (which user requested i.e use mode credential) 334 and then a message is generated and sent to kiosk unit similar to that of how messages are received from the kiosk unit but the message here comprises of kiosk service and the appropriate timestamps and nonce which was received from the message IX′, X′ (in this case XI′, XII′) and new nonce and timestamp generated by the bank server module (stored on the request database with all the credentials associated with the transaction ID) along with transaction ID and send it to the kiosk unit over the network 335 after which the kiosk unit as specified earlier validates the credentials 336 and if validation is FALSE i.e 337 is FALSE then kiosk unit generates a termination message 338 and end 339 as depicted earlier and then send it to bank server module similar to what was depicted earlier, and if 337 is TRUE then kiosk unit now verifies whether the kiosk service is update if not i.e 340 is FALSE then bank server module accesses the kiosk service information and based on which the bank server module provides the service options 341 and then user selects on appropriate options and proceed and request for operations to be performed and then the kiosk unit before performing any service 342 generates a message 343 which depicts the operation which user has performed so that bank server module can make appropriate changes in the storage V.S.C 114 if necessary and terminate the transaction by updating the same on transaction database 118 and send the message of confirmation so that the operation is performed. The generated message comprises of Transaction ID generated by the kiosk unit as well so that if any anomaly takes place then the user can communicate with bank authority regarding the same, the generated message is

XI:h(Nonce_{bankserver}∥M∥K_{C2}∥IPₖᵢₒₛₖ∥IDₖᵢₒₛₖ∥TransactionIDₖᵢₒₛₖ∥Timestampₖᵢₒₛₖ∥OperationInfo∥Kiosk_{service}),

XII:h(M∥Timestamp_{bankserver}∥K_{C1}∥TransactionID∥Kiosk_{service}∥Nonceₖᵢₒₛₖ∥TransactionIDₖᵢₒₛₖ∥IPₖᵢₒₛₖ)

where

M=h(OperationInfo∥TransactionID∥TransactionIDₖᵢₒₛₖ∥K_{C1}l ∥Timestampₖᵢₒₛₖ∥K_{C2}∥Kiosk_{service}∥Nonceₖᵢₒₛₖ) using these credentials the kiosk unit generates the final message which is PublicIdentifierₖᵢₒₛₖ∥XI′∥XII′ where XI′, XII′ are as follows:

XI′:E_{K}_{_{C1}} (Timestampₖᵢₒₛₖ∥M∥Operation inf o∥XI∥kiosk_{service}∥IPₖᵢₒₛₖ),XII′:E_{K}_{_{C2}}(Nonceₖᵢₒₛₖ∥XII∥IPₖᵢₒₛₖ∥M∥Kiosk_{service}∥OperationInfo)

Once the credentials are generated then the kiosk unit sends the generated message to the bank server module 343 and once the bank server module attains these credentials then the bank server module validates the credentials i.e 343 bank server validates the credentials by accessing the attained message and computing hashes using credentials which are stored on the database (nonce, timestamps which was sent by the bank server module earlier in the previous exchange) and extracted from the message with the attained hashes from the message and if validation is not successful i.e 344 is FALSE then the bank server module discards the message and terminates the request after ΔT time and kiosk unit doesn't receive the message then kiosk unit also terminates the request, now if validation holds i.e 344 is TRUE then the bank server module updates the request database (adds kiosk transaction ID) and access the kiosk service which the kiosk requests on basis of which if necessary then bank server module updates the V.S.C storage or else the bank server module updates the request database and updates the credentials on the transaction database and send the update message (here M will comprise of information for the user) to the kiosk unit and then scrap the credentials from the request database associated with that transaction ID (both kiosk and bank server) 348, once the kiosk unit attains this message then the kiosk unit validates the credentials and displays the appropriate message intended for the user (M using the kiosk service which will be display in this case) this leads to 346 which is end of communication.

We now depict if Update was the requested service by the user then the bank server module generates new credentials and stores it on request database along with all other credentials and then sends it to kiosk unit by encrypting using the user credentials first and then by the kiosk credentials the initial generated message looks something like this (assume that message sequence is some Y):

Y: h(Nonceᵤₛₑᵣ∥IDᵤₛₑᵣ∥Nonce_{bankserver}∥OldK_{B1}∥NewK_{B1}∥Timestampᵤₛₑᵣ∥OldExpiry∥NewExpiry∥AccountNumber∥Use mode e_{credential}∥OldCVV∥NewCVV∥Timestamp_{bankserver}∥V.S.C_{service})

Z: h(OldCardNumber∥NewCardNumber∥Use mod e_{credential}∥OldK_{B2}∥NewK_{B2}∥V.S.C_{service}∥OldType & Provider∥NewType & Provider∥IDᵤₛₑᵣ∥Timestamp_{bankserver}∥TimestampᵤₛₑᵣII PublicIdentifier)

And generate the intermediate message using which the final message is

generated, the intermediate message(using existing long term keys) is as follows:

Y′:E_{K}_{_{B2}} (Timestamp_{bankserver}∥Y∥NewK_{B1}∥NewCardNumber∥NewType & Provider∥PublicIdentifier∥V.S.C_{service}), Z′:E_{K}_{_{B1}} (Nonce_{bankserver}∥Z∥NewK_{B2}∥NewExpiry∥AccountNumber∥NewCVV∥V.S.C_{service}h(IDᵤₛₑᵣ∥PublicIdentifier))

using these intermediate value now the bank server module generates a final message for the user which is

M_{N}:PublicIdentifierᵤₛₑᵣ∥E_{K}_{_{B1}} (PublicIdentifierᵤₛₑᵣ∥Y′∥Nonce_{bankserver})∥E_{K}_{_{B2}} (Timestamp_{bankserver}∥Z′∥Use mod e_{Credentials})

and now this generated message is then appended with appropriate kiosk service and message using the long term keys of the kiosk and the kiosk public identifier, which are extracted using the kiosk storage.

A:h(Nonce_{bankserver}∥M_{N}∥K_{C2}∥Identityₖᵢₒₛₖ∥Kiosk_{service}∥Timestampₖᵢₒₛₖ), B:h(PublicIdentifierₖᵢₒₛₖ∥Timestamp_{bankserver}∥M_{N}∥K_{C1}∥Kiosk_{service}∥Nonceₖᵢₒₛₖ)

A′:E_{K}_{_{C1}} (Timestamp_{bankserver}∥M_{N}∥B∥Kiosk_{service}), B′:E_{K}_{_{C2}}(Nonce_{bankserver}∥A∥M_{N}∥Kiosk_{Service})

Here the final generated message is PublicIdentifierₖᵢₒₛₖ∥A′∥B′ and send it to the kiosk unit and then the kiosk unit attains these credentials and assuming that the validation was successful 337 is TRUE and 340 is also TRUE, the kiosk unit extracts kiosk service in this case display M_{N} in the form of a QR code and request OTP (Nonce of bank server in the message intended for the user), once the kiosk unit displays the information in the form of a QR code 349 the user is required to scan the QR code, for this the user uses the interface in scan mode and then the access module decodes the captured QR code on the interface and then accesses the service information from the message M_{N} and then sends the credentials to the security module along with the long term keys, now the security module validates the attained credentials and then the security module accesses the Nonce information and sends it to access module (redirect request) along with confirmation message (enter the OTP on the kiosk and wait for confirmation at the kiosk and then confirm the update process at the interface) by the network & confirmation module (extracted from the V.S.C service, as depicted earlier based on this information, the information is directed to different modules and appropriate functioning is done based on this V.S.C service information and once the service is performed all the credentials and information is directed to this access module) to the display & selection module and once the display & selection module attains these credential then OTP (nonce from bank server) is displayed along with warning message and now the user enters the OTP at the kiosk unit 350 and waits till a success message is not displayed on the kiosk, for this the entered OTP is encrypted and sent to the bank server module similar to that of 328,329 after which the validation request is sent to bank server module similar to that of 344-348. Here once the confirmation message is attained then the user selects the confirm option and then the request is directed to network & confirmation module which then allows the access module to proceed further, here the access module attains the credentials from the message M_{N} and then sends request to V.S.C 201 which directs to authentication & verification info module 204 to update the credentials on 202, the request is directed from 204 to 205 which then updates the same on 202, thus this is how old V.S.C credentials are updated with new credentials.

Here when the credentials are updated at the bank server module on the transaction database 118 and on storage V.S.C (when update mode is used as use mode by the user) 114, the credentials are updated with all the credentials on the request database 117, previous credentials and new credentials, this is done because if any malicious user has changed the credentials then user can approach bank authority and inform regarding the same.

As depicted earlier all the information associated to services are stored on storage units 104,106,119 i.e based on this service information all the entities are able to perform necessary operations when message highlighting these services are present.

Another important thing to note here is that if suppose any communication does not satisfy ΔT≤X will be terminated by the bank server module and also kiosk unit by updating the transaction database and scrapping the credentials from the request database, moreover if no operation is performed at the kiosk and the clock at the QR code & scrap module is completed then this module will send request to V.S.C to set access module of the V.S.C to disable and scrap off all the credentials in the memory associated with any of the generated or attained credentials.

Here Same process is followed for setting up PIN but PIN is not updated on the V.S.C or transaction database, but only on the storage V.S.C. Here the user access the interface in banking relation operation mode (under use mode credentials) and then once the options are displayed then the user selects setup PIN and then the PIN is set for that V.S.C and confirmation is sent to bank server module (by appending appropriate service information) which then updates it on the storage V.S.C.

Important point to note is that, usually kiosk and web servers are individual entities and can be identified easily, thus V.S.C is not deployed for these entities, as associated credentials are infrequently changed here and both of these entities are responsible only for facilitating services and providing them to the user but not performing them, although both the entities perform almost similar function but they do not possess a virtual smart card. The credentials change request can be physically made when servicing is done for the kiosk unit.

The use mode credentials and the service information are directing blocks for all entities as based on this information only these entities are able to perform and provide appropriate functionalities.

It can be obvious from the above description that it is not possible to use the merchant V.S.C for banking operations as they do not possess credentials required for performing and moreover if some malicious user tries to use the merchant V.S.C for banking then whenever the kiosk unit sends the validation request it will be rejected as no user associated with the public identifier will exist on storage V.S.C and error message will be sent.

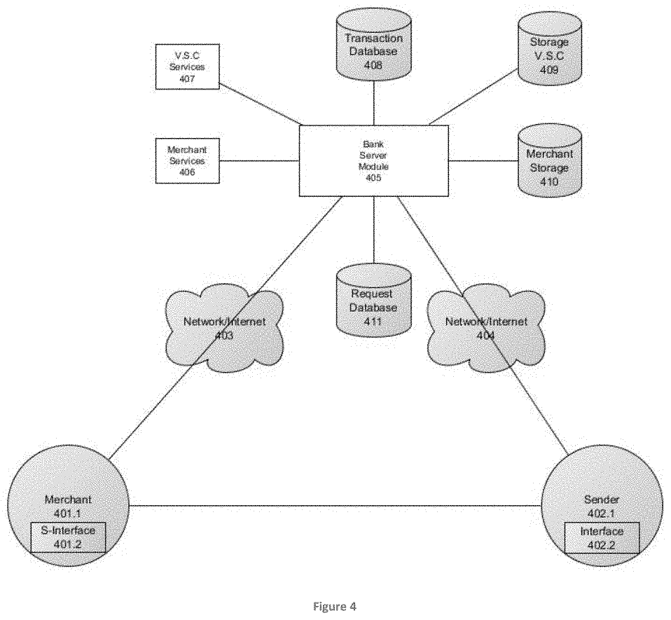

FIG. 4. Depicts as of how payments can be made using a merchant based Virtual smart card.

The main purpose of merchant V.S.C 209 is that it should be deployable on multiple devices so that the appropriate payment can be received and directed to user's account (who owns the merchant V.S.C) which can be accessed by the user V.S.C only, thus merchant V.S.C can be used on multiple devices for accepting payments and directing to the account of the user who owns the V.S.C. Both merchant and user V.S.C are different and credentials of both the V.S.C are different i.e 202,210 are different and are associated with different card's. The merchant V.S.C can be used only in receive mode, thus the merchant can easily deploy this one merchant V.S.C on multiple devices without any hesitation, Here the merchant V.S.C is stored on merchant storage 410 along with the S-Interface 401.2, The merchant storage 410 also comprises of information associated with public identifier of the user (who owns the V.S.C) thus a merchant V.S.C is linked with user V.S.C and any amount which is received using the merchant V.S.C is updated on user V.S.C, for this the public identifier information is accessed from the merchant storage 410 and then amount is reflected on storage V.S.C 409 of the user by accessing the same public identifier from the V.S.C storage 409 and updating the balance. We now proceed by depicting as of how the above process works.

Here the merchant accesses the interface providing authentication set for the interface and for V.S.C, once the authentication is validated by the authentication module of the S-interface 214 then the merchant accesses the interface in receive mode and once that is done the merchant is required to enter the amount which the merchant desires(with the help of display & selection module) this becomes Use mod e_{credentials} i.e the receive mode and the amount. Once the amount is entered then the use mode sends the request to network & confirmation module to generate a confirmation request for the entered amount, which then the network & confirmation module generates and sends it to display & selection module and then initiates the communication(here access module also attains this Use mod e_{credentials} information and directs to message assembler) with the bank server module by sending the IP Address and Public Identifier of the merchant, for this the network & confirmation module sends request to access module and access module sends the Public Identifier of the merchant V.S.C, in the mean while the Random Number & timestamp module generates a Random number and appropriate timestamp as of when the message is generated, and the access module requests the network & confirmation module to revert back IP Address of the device to the access module which this module sends to the security module(which encrypts the credentials using the long term keys K_{D1},K_{D2}) 215 along with V.S.C credentials which is directed by authentication & verification info module 212 of the merchant V.S.C 209, here once the public key certificate is attained from bank server module at the network & confirmation module, and once the confirmation module validates the certificate (by comparing with the list of granted digital certificate authorities) then the network & confirmation requests the access module to attain the public key from the certificate and then revert it to the security module, thus on the basis of this request the access module reverts back the public key to the security module and now the security module encrypts the message which was encrypted with the symmetric key with public key of the bank server module, once the credentials are encrypted then the credentials of the security module are then sent to message assembler module which as depicted assembles the message along with Transaction & save module which generates a random merchant transaction ID for reference and then revert and send the same to the network & confirmation module (sends this generated to bank server module) along with QR code & scrap module (which displays the QR code and starts the timer 216), and now the user is required to scan the QR code which is displayed on the merchant interface using the user interface in send mode (which allows the user to scan the depicted QR code on the screen), again as depicted earlier this scanned QR code is again encrypted with the long term shared key of the user V.S.C. We now proceed by depicting as of how the security module of merchant V.S.C generates the message then proceed by depicting as of how the security module of the interface proceed by encrypting the scanned QR code credentials.

Following is how the security module of the merchant interface initially generates the encrypted credentials; this message is generated using the credentials of the merchant V.S.C 209:

I:h(Nonce_{merchant}∥PublicIdentifier_{merchant}∥Timestamp_{merchant}∥K_{D1}∥Use mod e_{credential}∥IP_{merchant}∥CVV_{merchant}), I:h(Cardnumber∥Use mod e_{credential}∥K_{D2}∥Type & Provider∥IP_{merchant}∥PublicIdentifier_{merchant})

Using which the security module generates two blocks of final encrypted message which are:

I′:E_{K}_{_{D2}} (Timestamp_{merchant}∥I∥IP_{merchant}∥Use mod e_{credential}), II′:E_{K}_{_{D2}} (Nonce_{merchant}∥Use mod e_{credential}∥II∥IP_{merchant})

After the request public key has been attained now the security module encrypts these credentials with the public key and generates a final encrypted text.

E_{PUBLICKEYBANK} (I′/II′) which is then sent to message assembler module, once the message assembler attains this message the message assembler requests for a transaction ID and PublicIdentifier to both Transaction & save module and access module and they revert back with appropriate response and now the message assembler generates a final message M₁:PublicIdentifer_{merchant}∥TransactionID_{merchant}∥Use mod e_{credentials}∥E_{PUBLICKEYBANK} (I′/II40 ) which is then directed to both network & confirmation module and QR code generator and scrap module, here the QR code generator and scrap module (which again initiates the clock 216 and after the clock hits a particular time then all the generated credentials are scrapped from the memory) displays the information in the form of a QR code and network & confirmation module directs these credentials to the bank server module where bank server module attains the credentials of I′, II′ by decrypting it with the private key of the bank server module, once the bank server module attains the credentials then the bank server module validates the credentials by comparing with the generated hash and attained hash and if the credentials match then the bank server module generates a Transaction ID and saves all the attained information from the message M₁ on the request database, such as usemode credentials, nonce merchant, timestamp merchant, transaction ID merchant, IP merchant (used for redirecting the request to the IP so that network & confirmation module can attain the directed message and perform operation on basis of that), along with that the bank server module appends the timestamp of the bank server module also in the request database (used when user wants to send the message, thus all the generated credentials will be stored on the storage unit and will be used for generating message, same is done earlier as well), thus if the request for processing the amount doesn't come in some ΔT time then the credentials are updated on the transaction database as the status of incomplete and the credentials from the request database are scrapped out. Whereas if the validation doesn't match then the bank server module generates a transaction ID updates the request database and then updates the status of transaction on the transaction database as inconsistent or incomplete, and now if any payment request comes from the user associated with the merchant and the transaction ID it will be rejected as no request exists in request database associated with that transaction ID. Moreover now the bank server module will not revert any message to the merchant interface thus the clock 216 will run out (this will send a message to display & selection and QR code & scrap module of termination) and all the credentials will be scrapped out (using QR code & scrap module) by showing appropriate message on the display & selection module and then merchant will again create a request message and sends again. Assuming the message was validated and transaction ID and all associated information is stored on the request database, so Now the bank server waits for the response message from a user (in ΔT time) and if a valid response matching the credentials in the request database is attained then the bank server module processes the payment otherwise it is rejected.

We now proceed by depicting as of how the communication takes place between the user and bank server module.

Here once the user scanned the QR code displayed at the merchant interface, for this the user accesses the interface in send mode(this becomes the usemode credential), and then scans the QR code(in the meantime Random number & timestamp module generates random number and a timestamp, and sends to access module which directs it to security module) here once the user scans the QR code, the credentials of the QR code are decoded by the access module thus the access module attains the following message M₁: PublicIdentifier_{merchant}∥TransactionID_{merchant}∥Use mod e_{credentials}∥E_{PUBLICKEYBANK} (I′∥II′) and once the message is attained then the access module extracts the long term shared key and credentials from user V.S.C 201 which was depicted earlier, now once the decoded credentials are attained then the access module sends these credentials along with that of random number and timestamp credentials to security module where the security module generates the following message

III:h(Nonceᵤₛₑᵣ∥M₁∥K_{B2}∥Identityᵤₛₑᵣ∥Use mod e_{credential}∥Expiry∥PublicIdentifierᵤₛₑᵣ∥AccountNumber∥Use mod e_{credential}∥CVV∥IPᵤₛₑᵣ), IV:h(CardNumber∥Use mod e_{credential}∥Timestampᵤₛₑᵣ∥K_{B1}∥IPᵤₛₑᵣ∥Type&Provider∥IDᵤₛₑᵣ∥PublicIdentifierᵤₛₑᵣ)

now the security module using the generated credentials produce a final message which is as follows

III:E_{K}_{_{B2}} (Timestampᵤₛₑᵣ∥III∥IPᵤₛₑᵣ∥M₁∥Use mod e_{credential}∥Identityᵤₛₑᵣ), IV′:E_{K}_{_{B1}}(Nonceᵤₛₑᵣ∥IV∥M₁∥Identityᵤₛₑᵣ∥Use mod e_{credential}∥IPᵤₛₑᵣ)

Again as depicted earlier this message is sent to the message assembler module which generates the following M₂: PublicIdentifierᵤₛₑᵣ∥III′∥IV′ and then send it to the bank server module 405 over the network 403. Once the bank server module attains the request from the user then the bank server module initially attains user's long term keys (on the basis of public identifier) by extracting the information from the storage V.S.C 409 and then attaining the credentials from the message III′, IV′ and validating the attained message and if the validation is successful then the bank server module extracts the information from the decrypted messages, now the bank server module extracts the use mode credentials first (in this case “Send”) and on basis of which the bank server module now checks if the attained message M₁ (credentials) matches with the credentials stored on the request database (done by decrypting with the private key of the bank server and then comparing the information stored with the attained information), if so then the bank server module updates the request database credentials (associated with the same Transaction ID, comprising previously attained credentials, but stored as a new tuple) specifying the public identifier of the user and the use mode credential of the user (send mode in this case), after which the bank server module extracts the information associated with the user from the merchant V.S.C storage (as every merchant V.S.C is owned by a user and the public identifier of the user is stored on merchant V.S.C storage) 410 and interpret as of to whom the amount is to be transferred by accessing the storage V.S.C 409 and attaining credentials, now the bank server module attains the credentials of the user V.S.C on the basis of public identifier appended (user) in the message from storage V.S.C (as V.S.C public identifier information matches the public identifier information stored in merchant V.S.C) 409 and then accesses the balance information and then transfers funds from the user V.S.C (by accessing storage V.S.C associated with both the users) who wants to make payment to the user who used the V.S.C in receive mode, once this is done then request database is updated and then the bank server module generates a completion message and send it to both the entities and then update the transaction database and scrap all the credentials from the request database.

We now depict as of how the messages are generated and sent to user and the merchant (who used the V.S.C in receive mode, as depicted earlier that this V.S.C can be deployed to multiple merchant users along with interface, thus the acknowledgment message must be sent to the merchant user who requested the payment), for this the bank server module extracts the V.S.C services and extracts appropriate service (in this case generate confirmation payment) using which the bank server module extracts the long term keys of user (who used the V.S.C in send mode) from the storage V.S.C 409 and generates a confirmation message comprising of information such as Transaction ID (bank server), Transaction ID (merchant), Amount, Nonce (user and bank server) and Timestamp (user and bank server, here the bank server module generates a timestamp when the message is generated) which is appended with V.S.C service and sent to user's network and confirmation module over the network 404 the generated and sent message for the user the message generated are similar to that of what was received by the bank server module for the user, for which the bank server module generates an intermediate message

M₃:PublicIdentifierᵤₛₑᵣ∥TransactionID_{bankserver}∥UserUse mod e_{credential}∥MerchantUse mod e_{credential}∥Status

And using this message the bank server module generates a final message similar to III, IV, III′, IV′ but comprise of timestamp, status of the transaction, use mode credentials of both user and bank server module, transaction ID of merchant and of bank server module, along with M₃ in both III, IV (in this case V, VI) and III′, IV′ (in this case V′, VI′). Using these credentials the bank server module generates a final message which is M ₄: PublicIdentifierᵤₛₑᵣ∥V′∥VI′ and this generated message is sent to user over the network 404 to the network & confirmation module of the interface and then the access module attains the message(network & confirmation module directs to access module) M₄ and passes it to security module for decrypting and validating, once the validation holds then the message M₃ extracted by this module and is sent to display & selection module 215 of the interface, which displays the status of the transaction and all these credentials (merchant transaction ID, bank server transaction ID, transaction amount paid, status of transactions and others), these credentials are important as merchant use mode credentials depict what the amount was for confirmation again, whereas transaction ID of the bank server is for reference.

We now depict as of how the credentials are sent to the merchant over the network 403, here it is not a wise choice to encrypt using the long term keys of the merchant V.S.C as depicted earlier that it is possible that the merchant V.S.C is deployed at multiple places and can be accessed by multiple user, thus all the merchants who owns the same merchant V.S.C can interpret the exchanged message thus a new key must be generated and sent such that only the merchant interface (intended merchant who initiated the conversation) can attain the credential who initiated the communication. For this the bank server module uses the nonce, timestamp, transaction ID (merchant) and IP address of the device and then hash these credentials and generate a key K_{f} as the same key can only be generated by the merchant interface who initiated the communication, thus the bank server module generate the message similar to that of M₄ in this case M₅ but the credentials are encrypted with K_{f} and sent over the network 403 to the network & confirmation module of the merchant interface 215 after which the access module attains the credentials and sends it to security module after which the security module generates K_{f} using the previously generated credentials (accessing from the storage unit) the security module, and attains the credentials from the message and accesses the other previously credentials which is saved in the memory by the help of the access module, after which the access module reverts the credentials to the security module, once the credentials are attained at the security module then these credentials are used for validation by comparing with the stored credentials and if the validation matches then the message M₅ is directed to the display & selection module with appropriate service for saving the credentials which displays the message on the interface, so that the merchant can then save the transaction details if merchant desires.

Important point to note here is that all the credentials which are generated by both the entities for the duration of communication are stored on the storage unit of the respective devices till the clock 208,216 hit the ΔT mark.

Here a new key K_{f} is generated so that even if credentials associated with merchant V.S.C are compromised then also no entity will be able to manipulate the credentials as initially the credentials are encrypted using both merchant's symmetric key and bank server modules public key, thus only the bank server module can interpret the exchanged message, and now since giving a public key to all the merchants is not a best convenient option thus using the attained credentials the bank server module generates the message which only the merchant interface(who initiated the communication) can generate.

Important thing here is to note that we have specified different networks in the diagram so that it can be easily interpreted that message is reverted to the same channel from where it was received from.

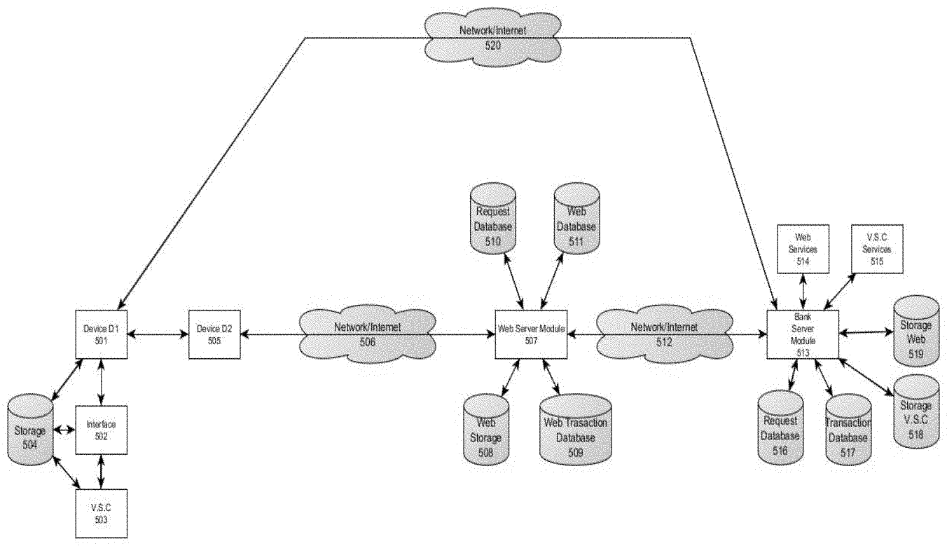

FIG. 5. Depicts how online transactions can be made using two devices 501,502 and two server modules 507,512. For this a user accesses online website (facilitated by the web server module) where the user has made some purchase for which the user wants to make payment. Here the amount is displayed on the web interface (provided by web server module 507) which the user is able to witness with the help of the interface (facilitated by the web server module) using the device D2 505 and the user then proceeds further by providing the credentials of the V.S.C which can only be validated by bank server module, We now proceed by depicting the same.

User accesses the web interface facilitated by the web server module 507 using device D2 505, here the user desires to make payment. For this, user performs a login operation by providing appropriate credentials, which are then sent to web server module via web interface over the network (initially encrypted with the public key of the web server module, for this web interface sends request to web server module and web server module provides the public key certificate to the web interface) 506, and web server module performs the usual validation operation (attaining these credentials by decrypting the credentials with the private key, which is known only to the web server module) by comparing the credentials with the web database 511 and if credentials match then the web server module performs authenticated key exchange (using approach depicted earlier in prior art, and along with key and session ID is also shared with the web interface for the device D2 so that any further communication can be addressed on the basis of this session ID and credentials to be exchanged be encrypted using the exchanged key) with the user device with the help of the web interface and now a session is established and now the web server module generates a session ID and stores this long term key along with it on the request database, and now the user is directed for payment, where the user is required to provide credentials for proceeding further, here user provides the card credentials which the user possesses in such a fashion that no useful information associated with the actual card credential is compromised, here the web interface displays the amount which the user is required to pay, here the user selects appropriate scan option at the web interface which enables the user camera on device D2 505, now the user must access device D1 501 in web payment mode (on the interface 502, this becomes use mode credentials) for this a QR code is generated at D1 501 by providing proper authentication if enabled (similar to what was depicted earlier), once the credentials are generated then user places the generated QR code in such a fashion that device D2 can capture the generated QR code with the help of the device camera and then the credentials are decode by the web interface once the QR code is captured, and send it to web server module by encrypting with the shared session key and appending appropriate message authenticators and session ID and amount and then message similar to III′, IV′ (but here the key is only one and the key is attained by authenticated exchange, and the hash message comprise of session ID appended, amount, decoded QR code, nonce, timestamp by the web interface and same are stored on the device D2 for further use if required) in FIG. 3 is generated and sent to web server module where M₁ is the QR code credentials similar to that of what was generated in FIG. 3 is generated at device D1. Once the credentials are attained at the web server module then the web server module 507 validates the credentials and if validation is unsuccessful then the message is scrapped off and since no reply will be sent to web interface over the network then the web interface will terminate (after some ΔT time) and redirect to different page by sending appropriate request to terminate the session to the web server module associated with the session ID, and then web server module will terminate the session from request database 510 and reflect the same on transaction database 509 and whereas if the credentials are correctly validated then the web server module generates a transaction ID and appends the same on the request database associated with the session ID and all the attained credentials from the web interface such as nonce, timestamps and message M₁ are also stored on the request database 510, and now the web server module 507 extracts long term keys and public identifier along with web service (in this case validate credentials) from the web storage 511 and then generates a message (using long term keys K_{W1}, K_{W2} between bank server and web server module) which is sent to bank server module for verification, this message comprises of transaction ID generated by the web server module and stored on the web server request database 510 along with encrypted credentials and authenticator for the message M₁ which the web server module 507 desires to validate, the generated credentials are as follows:

V:h(Nonce_{Webserver}∥M₁∥K_{W2}∥Identity_{Webserver}∥IP_{Webserver}∥Web_{Service}), VI:h(PublicIdentifier_{Webserver}∥Timestamp_{Webserver}∥Web_{Service}∥IP_{Webserver}∥M₁∥K_{W1})

Which leads to generation of message V:E_{K}_{_{W1}} (Timestamp_{Webserver}∥M₁∥V∥IP_{Webserver}∥Web_{service}), VI:E_{K}_{_{W2}} (Nonce_{Webserver}∥IP_{Webserver}∥Web_{Service}∥VI∥M₁) after which the web server module generates the final message which is M₂, the credentials are generated and sent to bank server module for verification M₂:E_{K}_{_{W1}} (VI′∥h(VI′∥Nonce_{Webserver}∥K_{W2}))∥E_{K}_{_{W2}} (V′∥h(V′∥Timestamp_{Webserver}∥K_{W1})), this generated message is appended with public identifier of the web server module thus the message becomes PublicIdentifier_{Webserver}∥M₂ which is now being sent (these credentials are stored on the request database 510 along with previous credentials for the transaction ID) to bank server module 513 over the network 512, once the bank server module validates the credentials and if validation fails then bank server module scraps the credentials and since no response will be attained to the web server module 507 in ΔT interval thus the web server module will then send appropriate failure message to the web interface for transaction ID on the device D2 505 and will terminate the session and redirect to a different section of the web interface, whereas if bank server validates the credentials then the bank server module validates the credentials in the message i.e M₁ is being validated now and if validation fails then the bank server module generates a termination message (by accessing web service and V.S.C service, which depicts the reason of termination) and send to the web server module and save the status of the transaction as inconsistent and transfer the same on the transaction database (by scrapping the credentials from the request database, similar to what was done earlier), on basis of the message the web interface displays the appropriate error message on the screen of the user, whereas if the validation is successful then the bank server module saves all the credentials of M₁, M₂ (both user and web server module credentials) on the request database along with the Transaction ID which the bank server module generates and now generates a successful validation message and send it to the web server module using the nonce and timestamp which were received earlier (of web server module), after which web server module now generates a transaction message (depicting the amount and transaction ID of web server which was generated earlier and other of what was received from the bank server module) similar to that of M₁ message (instead credentials are encrypted with long term shared key K_{W1}, K_{W2}) of FIG. 4, after which these credentials are stored (updated with current credentials and new generated credentials) on the request database 510 and directed through the web interface (encrypted with the shared session key along with authenticator) via 506, which displays the same in the form of a QR code (decrypting the attained credentials with the session key and validating the credentials) on the device D2 505 and then these same generated credentials are directed to the bank server module (similar approach which was depicted in FIG. 4, here web server based identifier and long term keys information is stored on 519), and bank server module 513 saves the credentials on the request database (on the basis of transaction ID which the bank server attained from the message) associated with the message such as nonce, timestamp and transaction ID of the web server (similar to that of what was done in FIG. 4) and now waits till the same request comes from the user for processing the transaction and as before the user scans the QR code (using device D1 501 which has V.S.C 503 and interface 502 embedded on it) and validates the amount then these credentials are encrypted with the shared key between the user and bank server module (which is accessed by the interface 502 from V.S.C 503, as depicted earlier) and then credentials are sent to bank server module via network & confirmation module and now bank server module extracts the credentials by decrypting the attained message on the basis of public identifier information appended on the attained message similar to that of message M₂ of FIG. 4, and checks for the stored credentials associated with the attained message and if there exists no transaction request on the request database associated with the public identifier then the bank server module terminates the request otherwise the transaction is completed then bank server module updates the credentials on the storage V.S.C's (as web server module comprises of a public identifier on basis of which the bank server module can interpret as of who is the owner and on basis of which transactions are performed) 518 associated with the amount i.e amount is deducted from the user's account who used the V.S.C is send mode and is transferred to the user V.S.C of user who owns the web server (identified by the bank server module on the basis of public identifier information of the web server which is linked to the V.S.C), once transfer is done then the status is updated on the transaction database 517 then intimation (after which credentials are scrapped from the request database 516 and updated on transaction database 517) is sent to both the web server module (generating appropriate message using web service 514, and sending over the network 512) 507 and the user device (generating appropriate message using V.S.C service 515, and sending over the network 520) D1 501, here once the web server module attains these credentials (over the network 512) then the web server module updates the request database (by validating the credentials and assuming it to be true) 518 credentials associated with the transaction and session ID after which the web server module updates the same credentials on the transaction database 509 and then generate a confirmation message and send to the using via web interface (encrypted with exchanged session key), and if failure of transaction took place the same will also be depicted.

If validation doesn't holds then the web server module sends the transaction ID (web server) and web server module public identifier to the user via web interface and so that user can communicate using the same with bank authority.

Important thing to note here is that bank server module can interpret easily as of who is requesting the communication on the basis of public identifier, as these public identifiers are defined in such a manner that on basis of interpretation only the bank server module can understand whether it is a merchant, user, kiosk or web server module who has initiated the communication.

The Web Database 511 comprises of all the user related credentials, thus using these credentials the web server module is able to initiate an authenticated key exchange, the protocol which is used is depicted in the prior art.

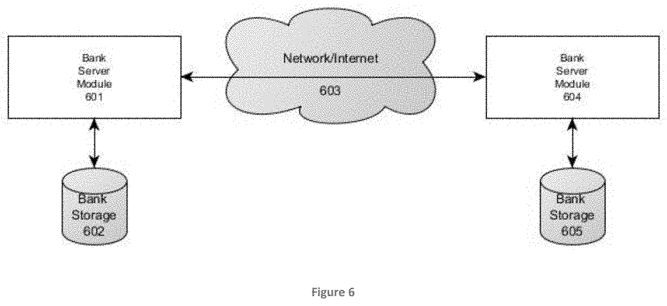

FIG. 6. All the previous communication depicted communication where user, merchant, kiosk were all facilitated by the same bank authority, thus communication was allied with the same bank server module by all the communicating entities, we now provide a brief overview as of how the communication can be processed when different bank server modules are involved, this happens when any one of the communicating entity possessing a V.S.C belongs to other bank authority.

We first depict the scenario when a person possessing a V.S.C and interface which is provided by bank authority of 604 and the user accesses at hardware module associated with 601. Here the user's interface generates the message associated with the credentials of V.S.C which is displayed in the form of a QR code similar to that of what was depicted in FIG. 3 after which user scans the QR code at the hardware module which as depicted redirects the request to bank server module 601, upon arrival bank server module 601 interprets as of to whom this V.S.C belongs on the basis of public identifier appended on the message, as the public identifiers are different for different banks thus on basis of this bank server module interprets that this public identifier belongs to a different bank authority, thus on basis of this bank server module 701 checks the bank storage 602 and then interprets that the sequence number (for instant public identifier starting with 101 and ending with 005 belongs to some bank authority) belongs to some bank authority and communication must be initiated with bank server module 604 for this the bank server module extracts the long term key from the bank storage 602 using which the bank server module appends the attained message (credentials which are forwarded by the kiosk unit of the decoded QR code) along with newly generated nonce, timestamp and message authenticators by the bank server module 601 after which the bank server module saves the credentials on the request database (by generating a transaction ID) and then request public key certificate of 604 similar to that of FIG. 4 but here transaction ID is also attached by the bank server module 601, after which the bank server module 604 reverts back the public key along with transaction ID (provided by 601 and a transaction ID of 604) then the bank server module 601 encrypts the credential on the request database and then send it to 604 (over the network 603, by appending appropriate public identifier and transaction ID's) after which the bank server module 604 decrypts the credentials with the private key and then validates the attained credentials which 601 sent, after which 604 validates the user credentials (QR code scanned at the kiosk) and then checks if PIN is enabled similar to FIG. 3 after which 604 generates a request message after which the request is encrypted by a new key (generated by 604 using approach depicted in FIG. 4) and encrypts using this symmetric key (by appending the message authenticator, Transaction ID generated by the 604) and send it (appending public identifier of 604 and depicting as of what is the nature of V.S.C i.e user V.S.C) to 601 over 603, and then 601 attains the credentials and validates credentials and attains the service message from the attained message after which the bank server module 601 accesses the service information from the message after which the bank server module requests OTP or PIN from the user by selecting the appropriate service from the V.S.C service and then sending the request to kiosk unit (transaction ID is also sent, this transaction ID is same as that of what was sent by 601 to 604), here once OTP or PIN credentials are entered then same are forwarded to bank server module 601 which then extracts the transaction information from the request database i.e bank server (both 601 and 604) transaction ID and stores these exchanged information on the request database and then forward the same to 604 using the exchanged session key (new key which was generated) which was stored on request database along with exchanged credentials and then send the user input credentials at the kiosk to 604, where the bank server module validates the credentials and if validation is successful then the bank server module 604 sends successful message to the 601 using the session key which was exchanged and then this bank server module, sends appropriate service request at the kiosk, and once user performs the request same request is sent to 604 by 601 over the network 603. If withdraw of money took place then the same is deducted from the user V.S.C (associated with the account) and then sent to bank server module 601 after which bank server module updates the same on request database, generate and send the message to kiosk and then update the same on transaction and bank storage 602, whereas 604 does the same.

We now depict how payment can be made when merchant V.S.C is provided by some bank authority and user V.S.C is provided by other bank authority. Here same thing happens as of what was depicted in FIG. 4, here the request is sent to bank server module by the merchant interface after which the user scans the QR code as depicted in FIG. 4, here once the QR code is scanned then again the request is directed to the respective bank server authority, here once the request is attained again on the basis of public identifier the bank authority say 604 identifies that the public identifier is associated with merchant of 601 thus now again the request attained from the user who scanned the QR code is then again encrypted with shared long term key between 601 and 604 after which 604 generates a transaction ID along with timestamp and nonce and all these encrypted credentials are stored on the request database of 604 and now 604 requests public key certificate of 601 by similar approach as that was depicted in FIG. 4 but transaction ID is also appended and once the public key certificate is being reverted by 601 along with the received transaction ID and new transaction ID to 604 via 603 then the 604 on the basis of transaction ID checks the request database (also stores the received database) and now encrypts by generating a new key and sending the credentials by encrypting it and now 601 attains and validates the message as before and then once confirmation message is sent to 604 over the network along with nonce and timestamp of 604 and new nonce and timestamp of 601 along with transaction ID generated by 601,604 and then the 604 validates the credentials by decrypting with new key and nonce and timestamp which were stored on request database associated with the transaction ID and now then the bank server module 604 deducts the prescribed amount attained from the message M₁ from the user's V.S.C and then sends the amount to bank server module 601 by encrypting all the credentials depicted earlier in FIG. 4 and once the same is attained then both the bank server module 604,601 update the request database and 601 transfers the same on transaction database and reflect on user V.S.C (to whom the fund is transferred using similar approach in FIG. 4) and bank storage 602, same is done by 604.

We claim a system comprising of a virtual smart card with a virtual smart card enabled interface to emulate physical smart cards used for performing banking operations and payment transactions,

1. A system for performing banking related operations and transactions comprising:
a. A virtual smart card (V.S.C) (201) or a merchant V.S.C (209) for having V.S.C credentials (202, 203) or merchant V.S.C credentials (210, 211) assigned to a user for identification, authentication of the user and are used for performing transactions or banking related operations desired by the user;
b. An interface (206) or a s-interface (214) for accessing the V.S.C credentials (202, 203) from V.S.C (201) or merchant V.S.C credentials (210, 211) merchant V.S.C (214) for generation of an encrypted QR code; the interface (206) or s-interface (214) authenticates the user and then proceeds for generation of the QR code; the interface (206) is also used for processing an encrypted QR code received at the interface (206) after authentication of the user;
c. A bank server module (108) for authenticating the user through the V.S.C credentials (202, 203) or merchant V.S.C credentials (202, 203) and then carrying out said banking related operations and said transactions; and
d. A hardware module (105) for assisting said banking related operations between the interface (206) and the bank server module (108);
e. A web server module (507) for validating the user by checking that the V.S.C credentials (202, 203) and the login credentials input at the web interface belong to the same user and then assisting said transactions between the interface (206) and the bank server module (108).

2. The system as claimed in claim 1, wherein the V.S.C module (201) and the interface module (206) are two embedded inbuilt modules of a client module (101); in case of a merchant user, the merchant V.S.C (209) and the s-interface (214) are the two embedded inbuilt modules of the client module (101).

3. The system as claimed in claim 2, wherein a V.S.C (201) is embedded on an interface (206) and is only accessible by the interface (206) and a merchant V.S.C (209) is embedded on an s-interface (214) and is only accessible by the s-interface (214).

4. The system as claimed in claim 3, wherein both the pair of V.S.C (201), interface (206) and merchant V.S.C (209), s-interface (214) are used for performing said transactions but only pair of V.S.C (201), interface (206) are used for performing said banking related operations.

5. The system as claimed in claim 4, wherein a communication carried out between s-interface (214) and interface (206) or two devices (501, 505) or between the hardware module (105) and the interface module (206) is in the form of the QR code.

6. The system as claimed in claim 5, wherein the interface (206) uses the credentials of V.S.C (201) and the s-interface (214) uses the credentials of merchant V.S.C (209) for generation of the encrypted QR code or for processing the encrypted QR code received at the interface (206).

7. The system as claimed in claim 6, wherein the client module (101) can have more than one V.S.C (201) and merchant V.S.C (209) embedded in it along with their respective interfaces.

8. The system as claimed in preceding claims, wherein an interface (206) or s-interface (214) for initiating said banking related operation comprising:
a. An authentication module authenticates the user and then lets the user access other modules of the interface (206) or s-interface (214) if only the authentication is successful;
b. A selection and display module lets the user interact visually with the interface (206) or s-interface (214); it takes input from the user and shows a respective output of the input given which might be diverted by other modules; it is also used for displaying error messages and confirmation request message;
c. A use mode module creates an appropriate request message of said banking related operation which the user wants to be performed for the bank server module (108) to interpret and carry it out;
d. A random number and timestamp module generates a random number for a QR code so that the generated QR code is variable and also generates a timestamp through which the bank server module (108) can check for the validity of a message obtained by decoding the generated QR code;
e. An access module accesses the credentials from V.S.C (201) or merchant V.S.C (209) and supplies it to appropriate modules to generate the QR code; it also attains information from different modules and forwards it to appropriate modules;
f. A security module hashes and encrypts or hashes and decrypts the message provided to it by appropriate modules using the long term keys assigned to the user and the public key of the bank server module (108) in a particular order;
g. A message assembler module assembles output from appropriate modules to generate an overall message;
h. A QR code generator and scrap module forms a QR code of the overall message and starts a clock timer (208,216) as soon as this module gets the message to form the QR code of; it erases the QR code it and all its details from the underlying modules once the times runs out; at times the interface also sends request to this module to start the timer when request is sent by appropriate module;
i. A network and conformation module sends to and receives messages from bank server module (108) and forwards it to appropriate modules for processing.

9. The system as claimed in claim 8, wherein a transaction and save module is included in s-interface (214) which generates and then saves a random transaction ID for a transaction for the identification of the transaction later.

10. The system as claimed in claim 9, wherein the use mode module in the s-interface (214) only allows receive mode and the use mode in the interface (206) allows all other modes but receive mode.

11. The system as claimed in claim 10, wherein the V.S.C (201) or merchant V.S.C (209) has an authentication and verification info module where any request for accessing the V.S.C (201) or merchant V.S.C (209) credentials by interface (206) or the s-interface (214) is directed to this module; if an authentication is enabled for V.S.C (201) or merchant V.S.C (209) then the request for authentication is sent by authentication and verification info module by the V.S.C (201,209) and if user gets authenticated then the authentication and verification info module sets the access module of the V.S.C (201) or merchant V.S.C (209) to enable state and then hands over the V.S.C credentials (202, 203) or merchant V.S.C credentials (210, 211) to the access module of the interface (206) or the s-interface (214).

12. The system as claimed in claim 11, wherein the V.S.C (201) a merchant V.S.C (209) linked to it so that the transaction completed by s-interface (214) of the merchant V.S.C (209) can be reflected on the account linked to the V.S.C (201).

13. The system as claimed in preceding claims, wherein a bank server module (108) for carrying out said transactions or said banking related operations comprising:
a. A storage V.S.C stores credentials assigned to every user;
b. V.S.C services consists of services which when sent to and received by an interface (206), carries out that action;
c. A kiosk storage stores long term keys assigned to a hardware module (105);
d. Kiosk services consists of services which when sent to and received by a hardware module (105), carries out that action;
e. A merchant storage stores credentials assigned to a merchant;
f. Merchant services consists of services which when sent to and received by a s-interface (214), carries out that action;
g. Web services consists of services which when sent to and received by a web server module (507), carries out that action;
h. A request database stores the said transaction details or details of said banking related operation along with their transaction IDs till said transaction or said banking related operation is completed and appropriate credentials are transferred to the transaction database;
i. A transaction database stores the said transaction details or details of said banking related operation along with their transaction IDs after said transaction or said banking related operation is completed or rejected.

14. The system as claimed in claim 12, wherein storage V.S.C and V.S.C services are used by the bank server module (108) to interact with the interface (206), kiosk storage and kiosk services are used by the bank server module (108) to interact with the hardware module (105), merchant storage and merchant services are used by the bank server module (108) to interact with the s-interface (214) and web services is used by the bank server module (108) to interact with the web server module (507).

15. The system as claimed in 14, wherein an interface (402.2) makes a transaction with a s-interface (401.2) where a QR code is generated by the s-interface (401.2) and the interface (402.2) scans it from the s-interface (214).

16. The system as claimed in claim 15, wherein both the interface (402.2) and the s-interface (401.2) each send a decoded message of the QR code to the bank server module (108) so that the bank server module (108) can carry out said transaction after matching the extracted transaction details from both the messages sent by the interface (402.2) and the s-interface (401.2).

17. The system as claimed in claim 14, wherein an interface (102) performs a banking related operation by interacting with a hardware module (105); the hardware module scans and decodes a QR code generated by the interface (102) which further interacts with a bank server module (108) for the bank server module (108) to carry out a banking related operation with the help of hardware module which communicates back and forth for the same.

18. The system as claimed in claim 17, wherein the hardware module (105) directs the decoded message to the bank server module (108) after processing it with its long term keys and public identifier stored in a storage (106); the bank server module (108) after recognizing the hardware module (105) and V.S.C (103) with their public identifiers appended with the message received, processes the message with the long term keys of the hardware module (105) and credentials of the V.S.C (103) stored in kiosk storage (112) and storage V.S.C storage (113).

19. The system as claimed in claim 18, wherein the bank server module (108) checks for whether the V.S.C (103) has a PIN set; if a PIN is set then the bank server module (108) requests for the PIN from the user through hardware module (105) else the bank server module (108) generates an OTP, encrypts it and sends it through the hardware module (105) to the interface (102); the bank server module then carries out the said banking related operation if the PIN or OTP received is correct.

20. The system as claimed in claim 19, wherein a user can change its V.S.C credentials (202, 203) when they get expired or compromised at the hardware module (105) using update mode in the use module of the interface (102); the bank server module (108) sends encrypted new credentials to the hardware module (105) so that only the interface (102) on which previous V.S.C credentials were stored can access it from the hardware module (105).

21. The system as claimed in claim 14, wherein a web server module providing a web interface which is accessible by a device D2 (505) interacts with the interface (502) for the interface (502) to initiate a transaction by generating an encrypted QR code; the QR code is scanned by the device D2 (505) which decodes it and then directs a decoded message of the QR code to the web server module (507) for validation of the user.

22. The system as claimed in claim 21, wherein the web server module (507) processes the decoded message with its credentials stored in the web storage (508) and then further directs it to the bank server module (513) and to the device D2 (505) using the web interface; the communication between the web interface and web server module (507) is encrypted with a session key which they exchange through a key exchange protocol.

23. The system as claimed in claim 22, wherein the interface (502) scans a QR code from device D2 (505) which is generated by the device D2 (505) from the message sent by the web server module (507); the interface (502) decodes the QR code, processes the decoded message with its V.S.C credentials (202, 203) and then sends it to the bank server module (513) for it to carry out said transaction after validating transaction details.

24. The system as claimed in preceding claims, wherein the modules interacting with the bank server module (108) or the web server module (507) send their messages encrypted with respective public keys of the bank server module (108) or web server module (507); the messages can be decrypted by the respective private keys of the bank server module (108) or web server module (507) where the attained credentials can later be validated and used for generation of new key or generating a transaction ID and handling the attained request;

25. The system as claimed in claim 24, wherein the bank server module (108) or the web server module (507) further generates a session key using nonce, timestamp, transaction ID of the interacting module, and IP address of the device in which the interacting module is embedded; communications further taking place between the interacting module and the bank server module (108) or the web server module (507) are then encrypted and decrypted with the generated session key.

26. The system as claimed in claim 25, wherein every said transaction or banking related operation is identified by the transaction ID generated by bank server module (108); the web server module and the s-interface (214) also generate their own transaction IDs to track the transactions taking place and all the set of transaction IDs are reflected on respective databases and storages.

27. The system as claimed in 26, wherein a bank server module (601) can identify a communicating user V.S.C (201) that to which bank that user belongs using the public identifier of the V.S.C; every bank is allotted a range of public identifiers which is stored in bank storage (602); the bank server module (601) can direct the communication to the bank server module (604) after identifying that the user V.S.C belongs to the bank associated with the bank server module (604).
